(19) United States
(12) Patent Application Publication
(10) Pub. No.: US 2008/0064469 A1
(43) Pub. Date: Mar. 13, 2008

(54) Game system including slot machines and game control method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/889,301

(22) Filed: Aug. 10, 2007

Related U.S. Application Data
(63) Continuation of application No. 11/639,170.
(60) Provisional application No. 60/844,119, filed on Sep. 13, 2006.

(51) Int. Cl. A63F 13/00

(52) U.S. Cl. 463/16; 463/21

(57) ABSTRACT

A game system including: slot machines each including a controller which controls at least a basic game and a second game and being capable of making a transition to the second game when a predetermined condition is established in the basic game; a second game device which is provided as a physically separate device from the slot machines and performs the second game; a display adapted to display an image according to a game status of the second game, the display being visible from a plurality of players who are playing the second game at the slot machines and the second game device; and a center controller capable of communicating with the slot machines, second game device, and display. When the predetermined condition is established in the basic game executed at the plurality of slot machines, rights to execute the second game are generated, and second game starting request signals requesting execution start of the second game are sent. When the center controller receives the second game starting request signals and a predetermined start condition is established, the center controller causes the second game device to start the second game for the slot machines which have sent the second game starting request signals.

### CROSS REFERENCE TO RELATED APPLICATIONS

This application claims priority to co-pending U.S. provisional patent application Ser. No. 60/844,119 filed on Sep. 13, 2006, and which is incorporated by reference herein for all purposes.

### BACKGROUND OF THE INVENTION

1. Field of the Invention

The present invention relates to a game system including slot machines and a game control method.

2. Description of Related Art

As disclosed in U.S. Pat. No. 6,634,941 and U.S. Patent application publication No. 2004/110558, the conventional slot machine includes a slot machine which executes a free game or a bonus game which has a higher possibility for becoming advantageous to a player than the basic game, in addition to the basic game. The free game or the bonus game is one of the second games. In the second game, a probability for a specific combination associated with a prize becomes high as a special symbol is displayed, or a payout in the case of realizing the specific combination associated with a prize is set to be greater, in the disclosed slot machine, for example.

### SUMMARY OF THE INVENTION

A first aspect of the present invention is a game system including: a plurality of slot machines, each slot machine including a controller operable to control at least a basic game and a second game and being capable of making a transition to the second game when a predetermined condition is established in the basic game, each slot machine generating a right to execute the second game when the predetermined condition is established in the basic game and sending a second game starting request signal requesting execution start of the second game; a second game device performing the second game, the second game device being provided as a physically separate device from the slot machines; a display adapted to display an image according to a game status of the second game, the display being visible from a plurality of players playing the second game at the slot machines and the second game device; and a center controller capable of communicating with the slot machines, the second game device, and the display, the center controller operable to, when the center controller receives the second game starting request signal from at least one of the plurality of slot machines and a predetermined start condition is established, cause the second game device to start the second game for the slot machine having got the right to execute the second game and sent the second game starting request signal.

According to the game system of the first aspect of the present invention, when the predetermined condition is established in the basic game executed at the plurality of slot machines, the rights to execute the second game are generated, and the second game starting request signals requesting execution start of the second game are sent to the center controller. When the center controller receives each second game starting request signal and the predetermined start condition is established, the center controller performs the control to start the second game for the slot machine having sent the second game starting request signals.

A second aspect of the present invention is a game system comprising: a plurality of slot machines, each slot machine including a controller operable to control at least a basic game and a second game and being capable of making a transition to the second game when a predetermined condition is established in the basic game, each slot machine generating a right to execute the second game when the predetermined condition is established in the basic game and sending a second game starting request signal requesting execution start of the second game; a second game device performing the second game, the second game device being provided as a physically separate device from the slot machines; a display adapted to display an image according to a game status of the second game, the display being visible from a plurality of players playing the second game at the slot machines and the second game device; and a center controller capable of communicating with the slot machines, the second game device, and the display, the center controller operable to receive the second game starting request signal from at least one of the plurality of slot machines; determine whether to start execution of the second game; and when the execution of the second game is determined to start, cause the second game device to start the second game for the slot machine having got the right to execute the second game and sent the second game starting request signal.

According to the game system of the second aspect, when the predetermined condition is established in the basic game executed at the plurality of slot machines, the rights to execute the second game are generated, and the second game starting request signals requesting execution start of the second game are sent to the center controller. The center controller receives each second game starting request signal; determines whether to start execution of the second game; and when the execution of the second game is determined to start, performs a control to cause the second game device to start the second game for the slot machine having sent the second game starting request signal.

A third aspect of the present invention is a game system including: a plurality of slot machines, each slot machine including a controller operable to control at least a basic game and a second game and being capable of making a transition to the second game when a predetermined condition is established in the basic game, each slot machine generating a right to execute the second game when the predetermined condition is established in the basic game and sending a second game starting request signal requesting execution start of the second game; a second game device performing the second game, the second game device being provided as a physically separate device from the slot machines; a display adapted to display an image according to a game status of the second game, the display being visible from a plurality of players playing the second game at the slot machines and the second game device; and a center controller capable of communicating with the slot machines, the second game device, and the display, the center controller operable to receive the second game starting request signal from at least one of the plurality of slot machines, determine whether to start execution of the second game, and either, when the number of slot machines determined to start the execution of the second game has reached a certain number, cause the second game device to start the second game for the certain number of slot machines or, when a predetermined one of the slot machines each having sent the second game starting request signal is determined to start execution of the second game, cause the second game device to start the second game for the slot machine having sent the second game starting request signal.

According to the game system of the third aspect of the present invention, when the predetermined condition is established in the basic game executed at the plurality of slot machines, the rights to execute the second game are generated, and the second game starting request signals requesting execution start of the second game are sent to the center controller. The center controller receives each second game starting request signal; performs a control to determine whether to start execution of the second game; and either performs the control to, when the number of slot machines determined to start the execution of the second game has reached a certain number, cause the second game device to start the second game for the certain number of slot machines or performs the control to, when the predetermined one of the slot machines each having sent the second game starting request signal is determined to start execution of the second game, cause the second game device to start the second game for the predetermined slot machine having sent the second game starting request signal.

A fourth aspect of the present invention is a game control method executed in a game system, the game system including: a plurality of slot machines, each slot machine including a controller operable to control at least a basic game and a second game and being capable of making a transition to the second game when a predetermined condition is established in the basic game, each slot machine generating a right to execute the second game when the predetermined condition is established in the basic game and sending a second game starting request signal requesting execution start of the second game; a second game device performing the second game, the second game device being provided as a physically separate device from the slot machines; a display adapted to display an image according to a game status of the second game, the display being visible from a plurality of players playing the second game at the slot machines and the second game device; and a center controller capable of communicating with the slot machines, the second game device, and the display, the center controller operable to, when the center, the game control method including the steps of: receiving by the center controller the second game starting request signal from at least one of the plurality of slot machines; determining by the center controller whether a predetermined start condition is established; and causing by the center controller the second game device to start the second game for the slot machine having got the right to execute the second game and sent the second game starting request signal.

According to the game control method of the fourth aspect of the present invention, when the predetermined condition is established in the basic game executed at the plurality of slot machines, the rights to execute the second game are generated, and the second game starting request signals requesting execution start of the second game are sent to the center controller. When the center controller receives each second game starting request signal and the predetermined start condition is established, the center controller performs the control to start the second game for the slot machine having sent the second game starting request signal.

A fifth aspect of the present invention is a game control method executed in a game system, the game system including: a plurality of slot machines, each slot machine including a controller operable to control at least a basic game and a second game and being capable of making a transition to the second game when a predetermined condition is established in the basic game, each slot machine generating a right to execute the second game when the predetermined condition is established in the basic game and sending a second game starting request signal requesting execution start of the second game; a second game device performing the second game, the second game device being provided as a physically separate device from the slot machines; a display adapted to display an image according to a game status of the second game, the display being visible from a plurality of players playing the second game at the slot machines and the second game device; and a center controller capable of communicating with the slot machines, the second game device, and the display, the game control method including the steps of: receiving by the center controller the second game starting request signal from at least one of the plurality of slot machines; determining by the center controller whether to start execution of the second game; and when the execution of the second game is determined to start, causing by the center controller the second game device to start the second game for the slot machine having got the right to execute the second game and sent the second game starting request signal.

According to the game control system of the fifth aspect, when the predetermined condition is established in the basic game executed at the plurality of slot machines, the rights to execute the second game are generated, and the second game starting request signals requesting execution start of the second game are sent to the center controller. When the center controller receives each second game starting request signal, performs the control to determine whether to start execution of the second game; and determines to start the execution of the second game, the center control performs the control to cause the second game device to start the second game for the slot machine having sent the second game starting request signal.

A sixth aspect of the present invention is a game control method executed in a game system, the game system including: a plurality of slot machines, each slot machine including a controller operable to control at least a basic game and a second game and being capable of making a transition to the second game when a predetermined condition is established in the basic game, each slot machine generating a right to execute the second game when the predetermined condition is established in the basic game and sending a second game starting request signal requesting execution start of the second game; a second game device performing the second game, the second game device being provided as a physically separate device from the slot machines; a display adapted to display an image according to a game status of the second game, the display being visible from a plurality of players playing the second game at the slot machines and the second game device; and a center controller capable of communicating with the slot machines, the second game device, and the display, the game control method including the steps of: receiving by the center controller the second game starting request signal from at least one of the plurality of slot machines; determining by the center controller whether to start execution of the second game; and either, when the number of slot machines determined to start the execution of the second game has reached a certain number, causing by the center controller the second game device to start the second game for the certain number of slot machines or, when a predetermined one of the slot machines each having sent the second game starting request signal is determined to start the execution of the second game, causing by the center controller the second game device to start the second game for the slot machine having got the right to execute the second game and sent the second game starting request signal.

According to the game system of the sixth aspect of the present invention, when the predetermined condition is established in the basic game executed at the plurality of slot machines, the rights to execute the second game are generated, and the second game starting request signals requesting execution start of the second game are sent to the center controller. The center controller receives each second game starting request signal; performs the control to determine whether to start execution of the second game; and either performs the control to, when the number of slot machines determined to start the execution of the second game has reached a certain number, cause the second game device to start the second game for the certain number of slot machines or performs the control to, when a predetermined one of the slot machines each having sent the second game starting request signal is determined to start execution of the second game, cause the second game device to start the second game for the predetermined slot machine having sent the second game starting request signal.

### BRIEF DESCRIPTION OF THE DRAWINGS

FIG. 1 is a block diagram showing a system configuration of a game system according to one embodiment of the present invention.

FIG. 2 is a diagram showing an outward appearance of a game system according to one embodiment of the present invention.

FIG. 3 is a diagram showing a slot machine according to one embodiment of the present invention.

FIG. 4 is a diagram showing a front view of a display region of a slot machine according to one embodiment of the present invention.

FIG. 5 is a diagram showing a back side view of a schematic configuration of a liquid crystal display in a slow machine according to one embodiment of the present invention.

FIG. 6 is a diagram showing an expanded view of a part of a liquid crystal display shown in FIG. 5.

FIG. 7 is a block diagram showing an electric configuration of a controller of a slow machine according to one embodiment of the present invention.

FIG. 8 is a block diagram showing an electric configuration of a display/input controller of a slow machine according to one embodiment of the present invention.

FIG. 9 is a diagram showing a plan view of a second game device according to one embodiment of the present invention.

FIG. 10 is a block diagram showing an electric configuration of a controller of a center controller according to one embodiment of the present invention.

FIG. 11 is a diagram showing a second game terminal according to one embodiment of the present invention.

FIG. 12 is a block diagram showing an electric configuration of a controller of a second game terminal according to one embodiment of the present invention.

FIG. 13 is a diagram showing a configuration of a basic game random number table.

FIG. 14 is a diagram showing a configuration of a basic game payout table.

FIG. 15 is a diagram showing a configuration of a second game payout table.

FIG. 16 is a flow chart showing a flow of processing operation in a basic game in a slot machine according to one embodiment of the present invention.

FIGS. 17A to 17C are flowcharts showing the first mode of a processing operation of the second game in the game system according to the embodiment of the present invention.

FIG. 18 is a flowchart showing a second mode of the processing operation of the second game in the game system according to the embodiment of the present invention.

FIG. 19 is a flowchart showing a third mode of the processing operation of the second game in the game system according to the embodiment of the present invention.

FIG. 20 is a display example when a symbol combination of “BONUS” stops on a payline L5 of a display area in the basic game of the slot machine according to an embodiment of the present invention.

FIG. 21 is a display example displayed after FIG. 20 is displayed in the basic game at the slot machine according to an embodiment of the present invention.

FIG. 22 is a display example of the basic game at the slot machine according to an embodiment of the present invention which is waiting for the second game.

FIG. 23 is a display example when execution of the second game starts at the slot machine according to an embodiment of the present invention.

FIG. 24 is a display example of a screen notifying that execution of the second game is canceled at the slot machine according to an embodiment of the present invention.

FIG. 25 is a display example at a betting operation in the second game at the slot machine and second game terminal according to an embodiment of the present invention.

FIG. 26 is a display example asking whether to continue the second game at the end of the second game of the slot machine and second game terminal according to an embodiment of the present invention.

FIG. 27 is a display example showing gameover in the second game at the slot machine and second game terminal according to an embodiment of the present invention.

FIG. 28 is a table for determining whether to permit execution start of the second game of the slot machine and second game terminal according to an embodiment of the present invention.

### DETAILED DESCRIPTION OF THE EMBODIMENTS

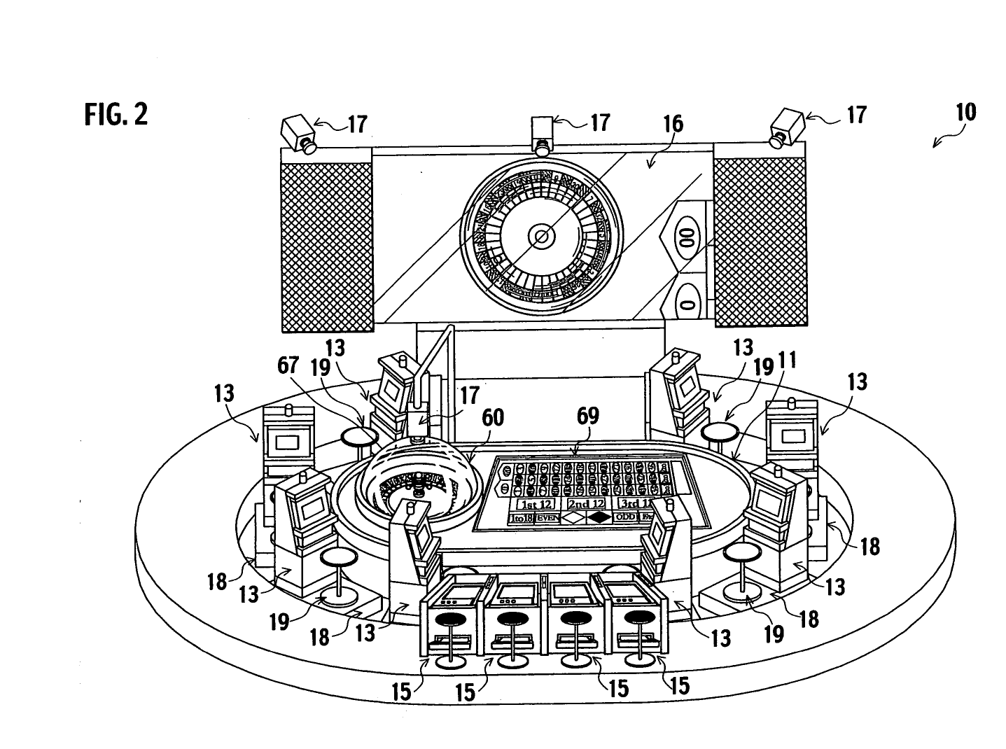

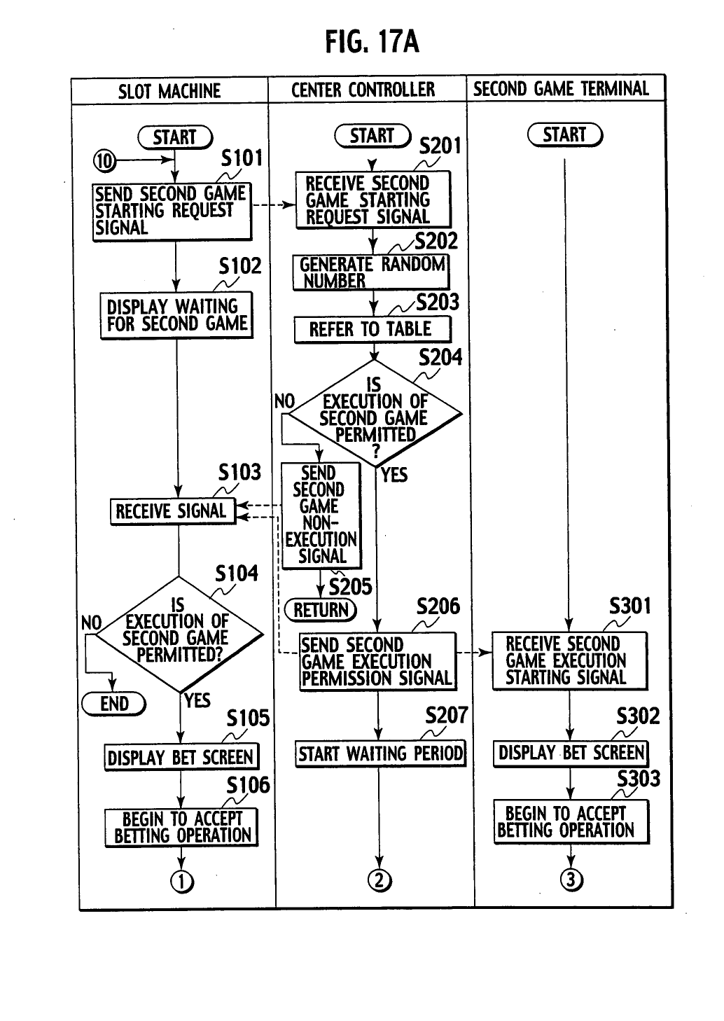

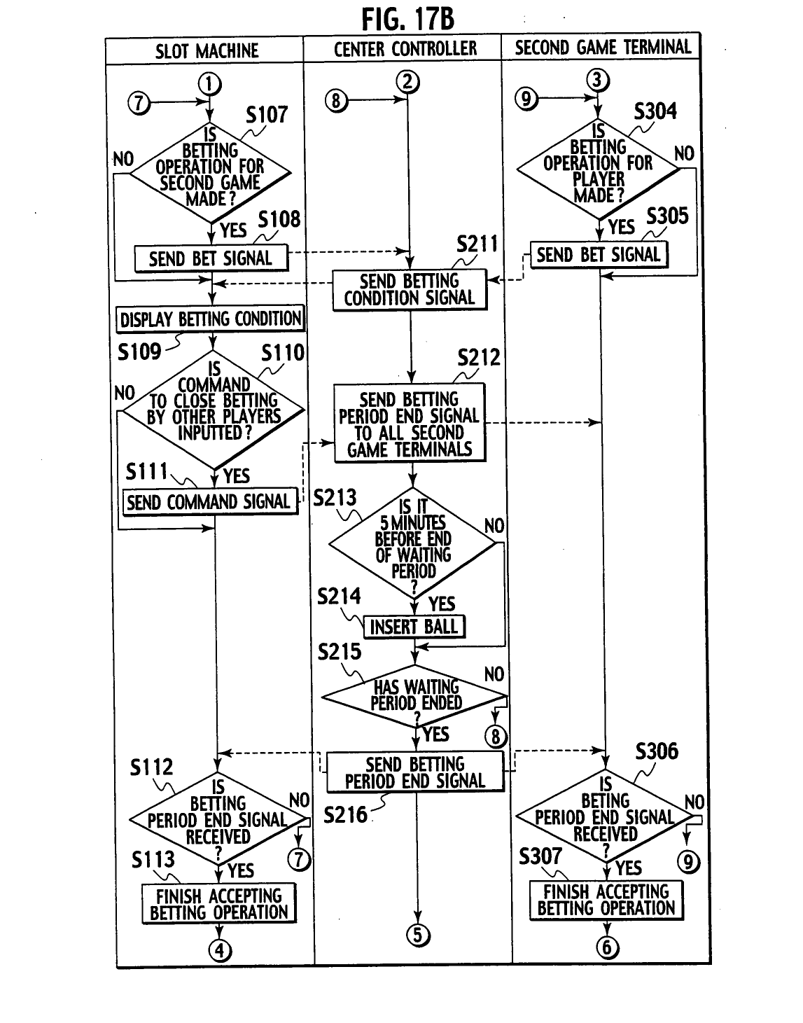

A schematic configuration of a game system 10 according to the present embodiment will be described according to FIG. 2. FIG. 2 is a diagram showing an outward appearance configuration of a game system 10 according to the present embodiment. As shown in FIG. 2, the game system 10 mainly comprises slot machines 13, a second game device 11, and second game terminals 15. The second game device 11 of the present embodiment is a game device for a roulette game. Besides a basic game to be described below with reference to FIG. 16, the slot machine 13 can make a betting operation for the roulette game as a second game to be described below with references to FIG. 17A to FIG. 17C, at a timing when a prescribed condition is realized.

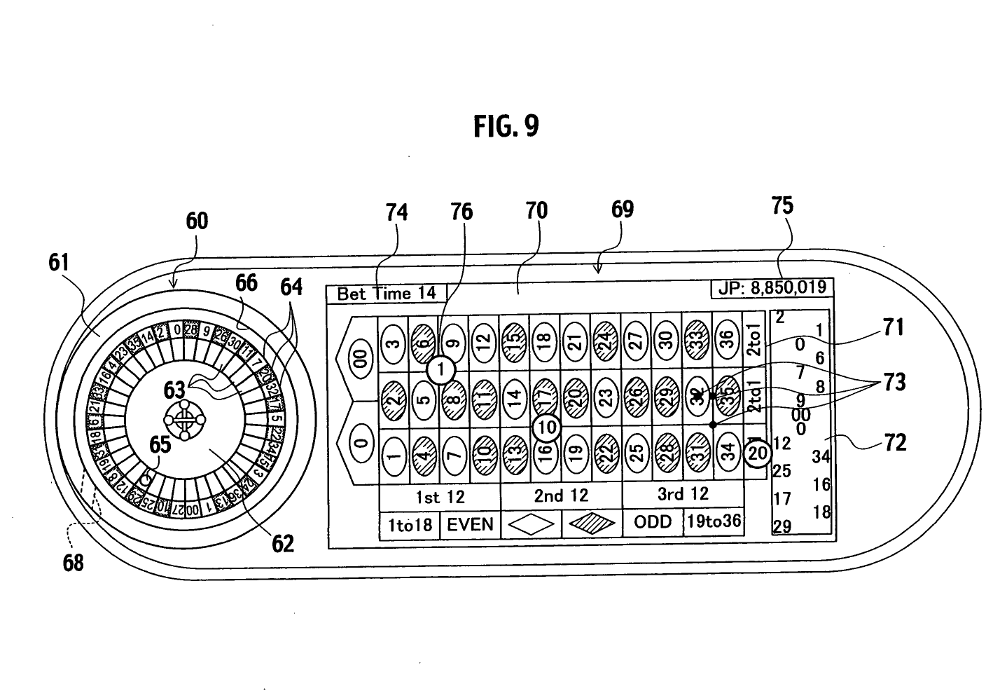

The game system 10 is provided with a large scale monitor 16 as shown in FIG. 2. On the monitor 16, a betting board 71 (see FIG. 9 to be described below) for indicating a betting state of a player, a BET time indicating a remaining time during which a betting can be made, and a content of a display 60 for displaying a winning number, etc., as a progress state of the second game (referred hereafter also as the roulette game), along with an image of the rotating roulette or an image of a player and the like taken by viewpoint movable cameras to be described below according to the need.

A plurality (eight in the present embodiment) of the slot machines 13 are provided in such directions that they are enclosing around second game device 11 and the players of the slot machines 13 can view the large scale monitor 16. A set of each slot machine 13 and a chair 19 for a player to sit are provided on a movable floor 18. It is configured such that, when the second game is started, the slot machine that made a transition to the second game will be raised integrally with the chair 19 as the movable floor 18 is raised.

In the game system 10, a plurality (four in the present embodiment) second game terminals 15 that can join in the roulette game are provided at positions from which the large scale monitor 16 can be viewed in front. The second game terminal 15 is a dedicated roulette game terminal, which is a terminal for enabling the other players to join that second game in the case where the second game is started by the slot machine 13.

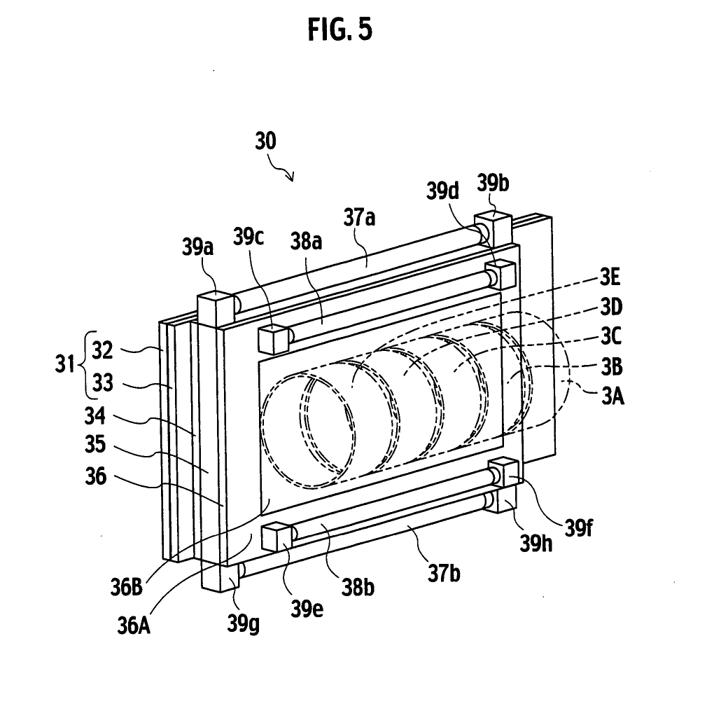

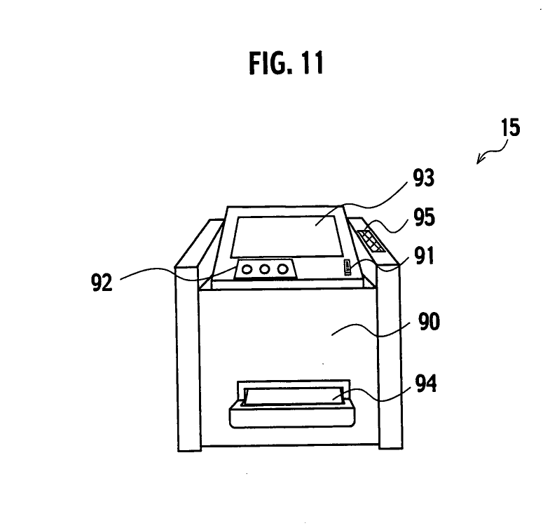

In the game system 10, a plurality (four in the present embodiment) of viewpoint movable cameras 17 are provided. One of the viewpoint movable cameras 17 is for taking an image of a roulette device 60 shown in FIG. 9 to be described below, which takes images of a rotation of the roulette and a position of a ball 65 when the roulette is stopped, and displays them on the monitor 16. The viewpoint movable camera 17 for taking images of the roulette device 60 is arranged such that images can be taken from an upper side of the roulette device 60 toward a downward direction vertically. The viewpoint movable camera 17 for taking images of the roulette device 60 may be made to take other images such as those of the players or the display 69 for displaying a BET screen 70 containing the betting board 71 to be described below, before the roulette is rotated. The other viewpoint movable cameras 17 are provided on an upper face of the monitor 16 in order to capture facial expressions of the players. The images taken by the viewpoint movable cameras 17 are displayed on a liquid crystal display 30 (see FIG. 5) of the slot machine 13 and a display 93 (see FIG. 11) of the second game terminal 15, besides the large scale monitor 16. The game system 10 formed by these elements is provided within a gaming facility such as casino.

The slot machine 13 is changed from a terminal for playing the basic game to a terminal for playing the roulette game at a timing when a prescribed condition of having a specific symbol combination stopped on a payline is realized, as will be described below, such that the player can play the roulette game. Note that, in the case where the roulette game is to be started, the other slot machines which are playing the basic game at that point and for which the above described prescribed condition is not realized can also join the roulette game. Then, the betting can be made on the betting board 71 of the BET screen 70 to be described below, or the betting can be made on whether the bet made by the player who made a transition to the roulette game is going to win or lose.

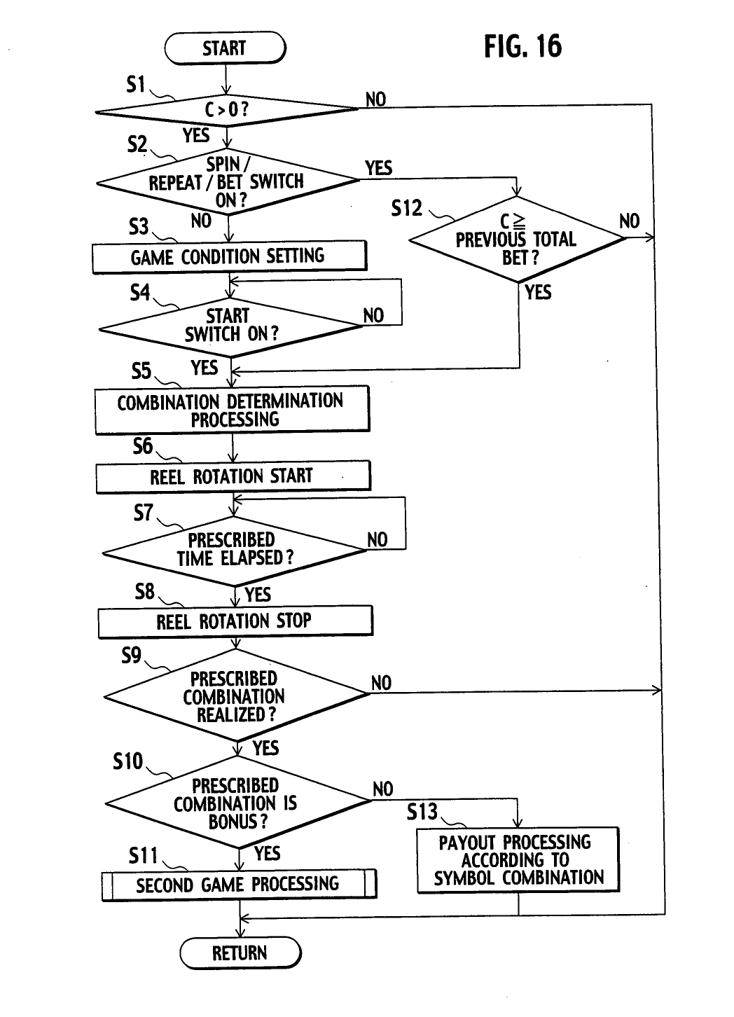

By preparing a second game payout table which is different for each terminal as shown in FIG. 15 to be described below, it is possible to set a prize in a case where the bet by the slot machine 13 for which a prescribed condition is realized becomes win to be different from a prize in a case where the bet by the slot machine 13 for which a prescribed condition is not realized becomes win.

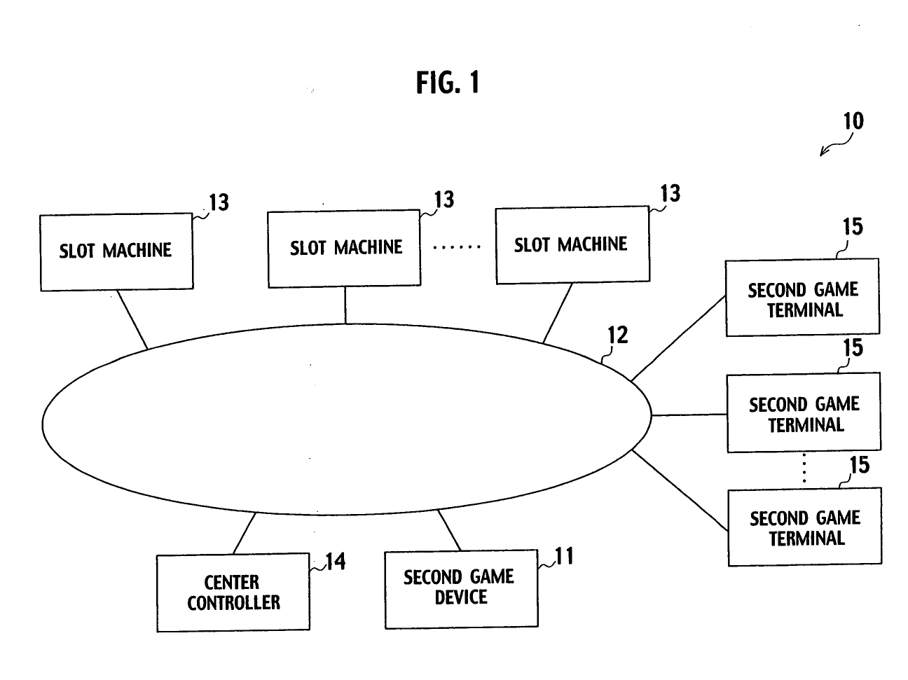

FIG. 1 is a block diagram showing a configuration of the game system 10 according to the present invention. In the game system 10 shown in FIG. 1, the slot machines 13, the second game device 11, a center controller 14 and the second game terminals 15 are connected to a network 12. The center controller 14 can control the slot machines 13, the second game device 11 and the second game terminals 15 through the network 12.

Each slot machine 13 is a slot machine by which the player can play the basic game. The slot machine 13 itself carries out a control for making a transition from the basic game to the second game at a timing when a prescribed condition is realized. The second game is a game to be executed by the second game device 11, under the control of the center controller 14. In the case where the second game is started, the slot machine used by the player is made to function as a terminal for the second game, so that the player can make the betting operation for the roulette game. With such a configuration, the player can enjoy the second game using the second game device 11 which is physically separate from the slot machine 13.

Even for the slot machine 13 for which a prescribed condition is not realized, the center controller 14 carries out a control for enabling a selection to determine whether or not to join in the second game, when a prescribed condition is realized at another slot machine 13 and the second game by the second game 11 is started. With such a configuration, even the player of the slot machine 13 for which a prescribed condition is not realized can enjoy the second game using the second game device 11.

The second game terminals 15 are connected to the center controller 14 through the network 12. When the roulette game is started by the second game device 11, it is configured such that the second game can be played by using the second game terminal 15, apart from the slot machine 13. For this reason, it becomes possible for a third person present in the gaming facility to become a player of that roulette game by using the second game terminal 15, in response to the start of the roulette game. In this way, by giving the opportunity to join in the roulette game even to the other players who are not playing the basic game, it is possible to increase the interest with respect to the roulette game.

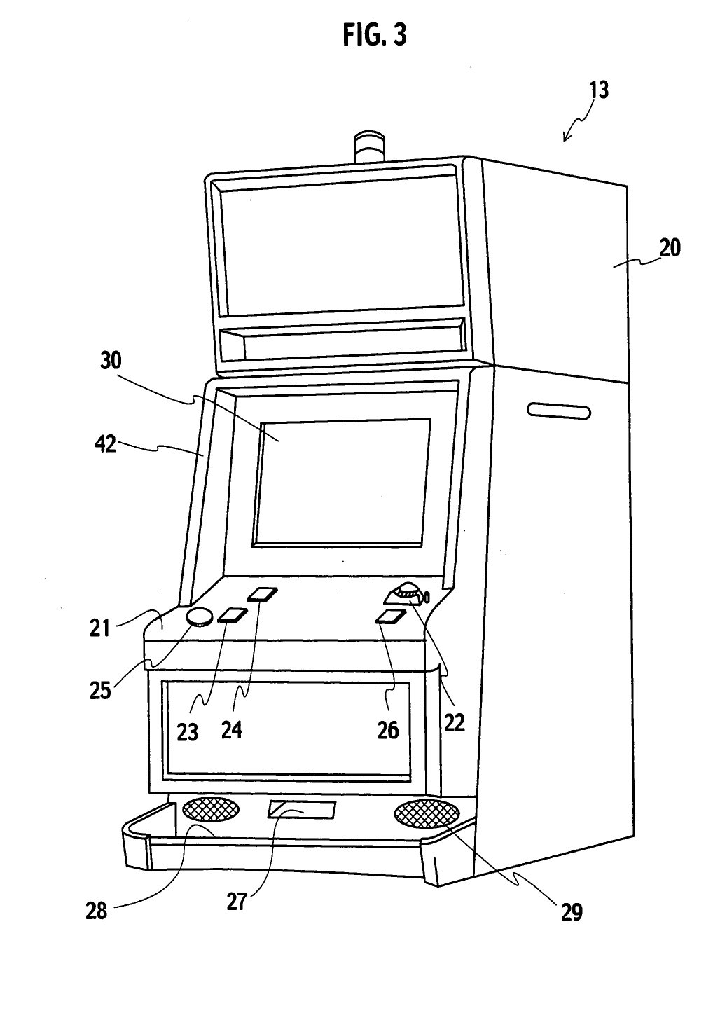

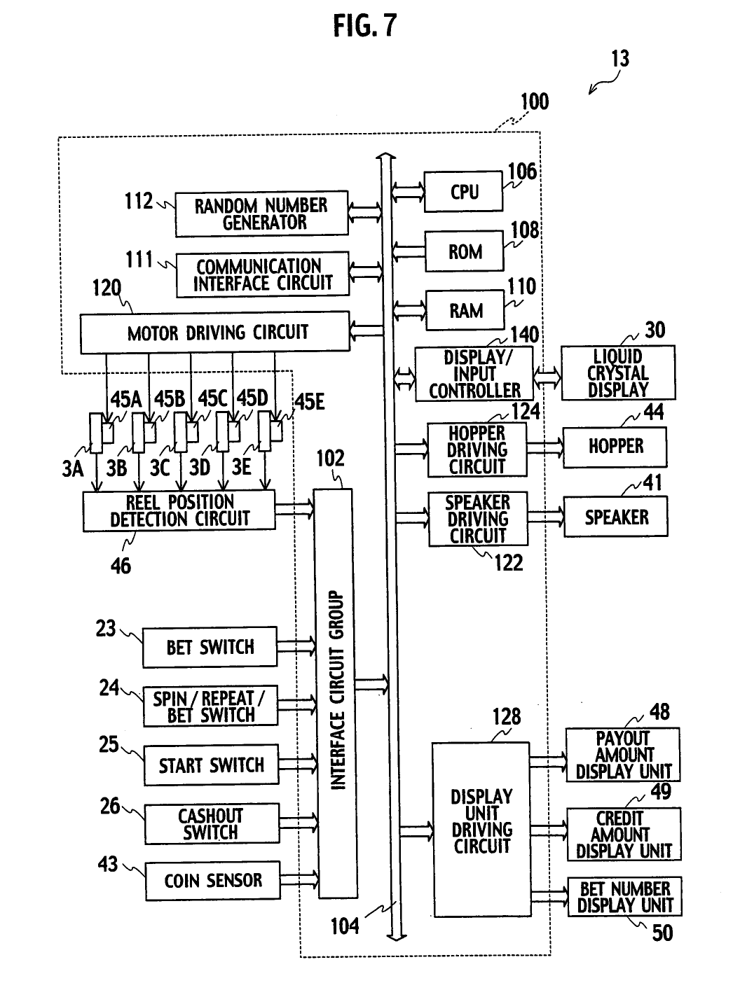

FIG. 3 is a diagram showing the slot machine 13 according to one embodiment of the present invention. The slot machine 13 has a cabinet 20 and a main door 42. The cabinet 20 has a side facing the player open. Inside the cabinet 20, various constituent elements including a controller 100 (see FIG. 7) for electrically controlling the slot machine 13 and a hopper 44 (see FIG. 7) for controlling input, deposit and payout of coins (game medium). The game medium is not limited to coins, and can be medals, tokens, electronic money, or electronic value information (credit) corresponding to these, for example

The main door 42 is an element for covering such that the inside of the cabinet 20 is not exposed to outside. At approximately center of the main door 42, a liquid crystal display 30 is provided.

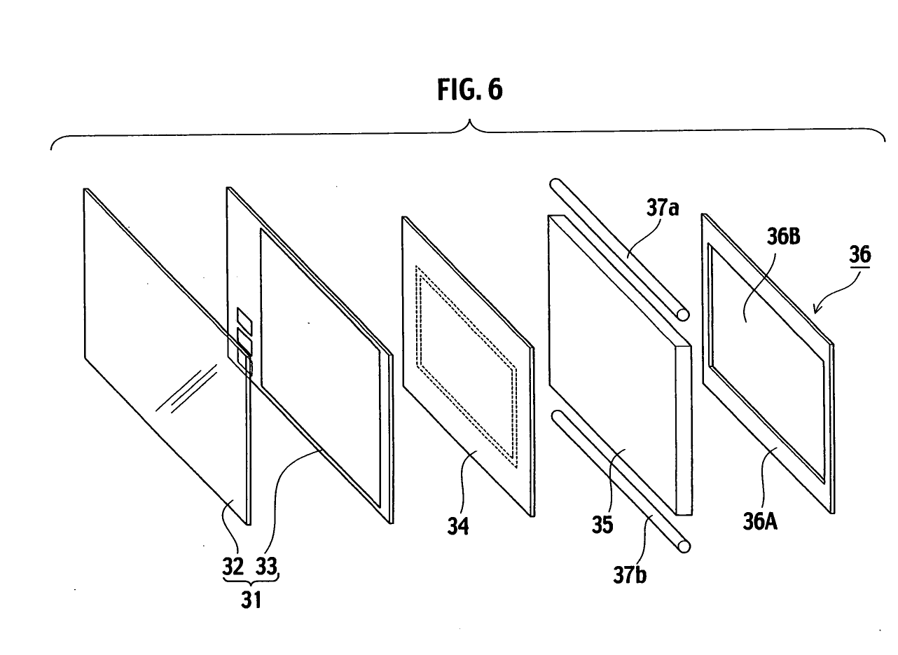

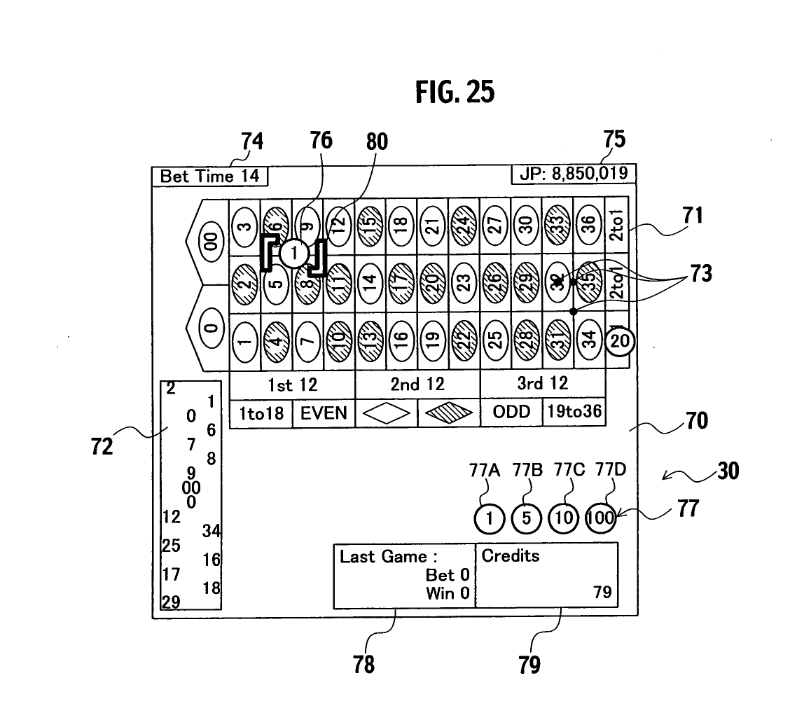

The liquid crystal display 30 is for displaying various images related to the game including effect images and the like. The player proceeds with the game while visually checking various images displayed on the liquid crystal display 30. In particular, in the roulette game, the BET screen 70 shown in FIG. 25 to be described below will be displayed on the liquid crystal display 30. The liquid crystal display 30 has a transparent liquid crystal panel 34 (see FIG. 5 and FIG. 6). The transparent liquid crystal panel 34 has its part or whole that can be switched between transparent/non-transparent states, and is capable of displaying various images. The detailed configuration of the liquid crystal display 30 will be described below.

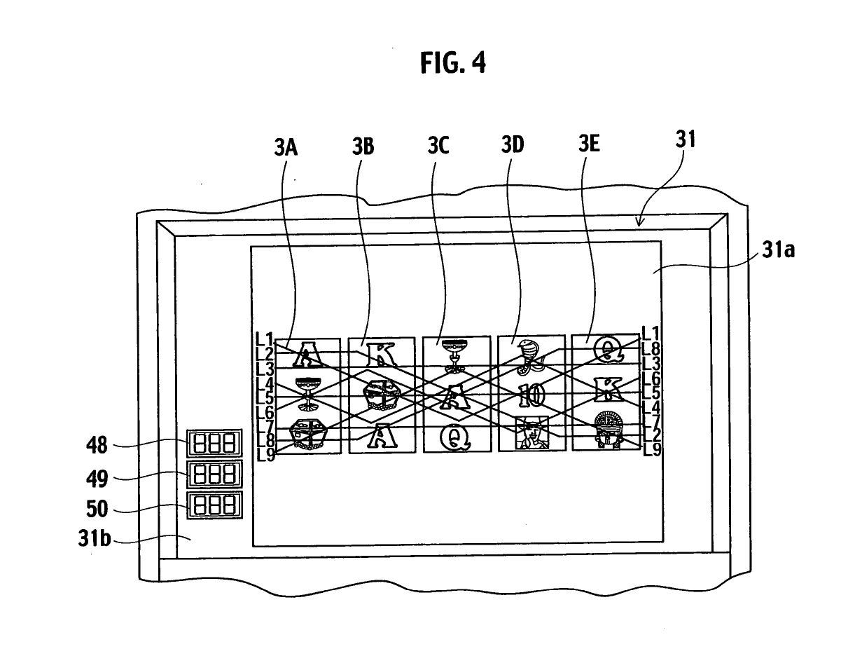

On the back side of the liquid crystal display 30, five mechanical reels 3A, 3B, 3C, 3D ad 3E (see FIG. 4 and FIG. 5) with a plurality of symbols depicted on their outer circumferential faces are provided to be rotatable and arranged along a horizontal line. The mechanical reels 3A to 3E are configured to display a plurality of symbols, in cooperation with stepping motors 45A, 45B, 45C, 45D and 45E (see FIG. 7) to be described below. On the outer circumferential faces of the mechanical reels 3A, 3B, 3C, 3D and 3E, a plurality of symbols needed for the basic game such as symbols “BONUS”, “WILD”, “TREASURE BOX”, “GOLDEN MASK”, “HOLY CUP”, “COMPASS&MAP”, “SNAKE”, “A”, “K”, “Q”, “J” and “10” are depicted. These various symbols on the mechanical reels 3A to 3E will become visible when the transparent liquid crystal panel 34 is in the transparent state.

On the lower side of the liquid crystal display 30, a roughly horizontal operation unit 21 is provided. On the right side of the operation unit 21, a coin slot 22 for entering coins into the slot machine 13 is provided. On the left side of the operation unit 21, a BET switch 23 and a spin/repeat/bet switch 24 are provided. The BET switch 23 is for determining which ones of nine lines L1, L2, L3, L4, L5, L6, L7, L8 and L9 for awarding prizes to be described below should be set active, and selecting the number of coins as the game medium to be bet on a line for awarding a prize that is set active (hereafter simply referred to as a “payline”). The spin/repeat/bet switch 24 is for playing the game again without changing the number of coins bet on the payline in an immediately previous game. By operating the BET switch 23 or the spin/repeat/bet switch 24 by pressing it, the number of coins to be bet on the payline is determined according to that operation.

In the operation unit 21, on the left side of the BET switch 23, a start switch 25 for accepting the basic game start operation of the player in each game is provided. The pressing operation on either the start switch 25 or the spin/repeat/bet switch 24 will become a trigger for the start of the game, and the rotation of the five mechanical reels 3A to 3E described above will be started.

In the operation unit 21, in a vicinity of the coin slot 22, a cashout switch 26 is provided. When the player presses the cashout switch 26, the entered coins are paid out from a coin payout opening 27 provided at the lower front portion of the main door 42, and these paid coins are accumulated in a coin tray 28. On the upper side of the coin tray 28 and on left and right sides of the coin payout opening 27, sound outlets 29 for propagating effect sounds generated from a speaker 41 (see FIG. 7) contained inside the cabinet 20 to outside the cabinet 20 are provided.

FIG. 4 shows a display region of the slot machine 13 in enlargement. The liquid crystal display 30 of the slot machine 13 has a front panel 31, and a transparent liquid crystal panel 34 (see FIG. 5 and FIG. 6) provided on a back side of the front panel 31. The front panel 31 is formed by a transparent display screen 31a and a design pattern formation region 31b on which design patterns are formed. The image information displayed on the transparent liquid crystal panel 343 provided on the back side of the front panel 31 will be visible through the display screen 31a of the front panel 31. When the region of the transparent liquid crystal panel 34 is in the transparent state, the symbols on the five mechanical reels 3A to 3E provided on the back side of the transparent liquid crystal panel 34 will be visible through the display screen 31a of the front panel 31.

On the left back side of the liquid crystal display 30, various display units including a payout amount display unit 48, a credit amount display unit 49, a BET number display unit 50 are provided. The design pattern formation region 31b of the front panel 31 has a transparent portion covering a front side of the various display units 48 to 50, so that the display contents of the various display units 48 to 50 will be visible.

The slot machine 13 has nine paylines L1 to L9 for awarding prizes, as shown in FIG. 4. Each one of these paylines L1 to L9 for awarding prizes is extended such that one symbol on each one of the mechanical reels 3A to 3E will pass through it when the rotation of all the mechanical reels 3A to 3E is stopped.

When the BET switch 23 is pressed once, the payline L3 for awarding the third prize, the payline L5 for awarding the fifth prize, and the payline L7 for awarding the seventh prize are set active, for example, and one coin is taken in as a credit medal.

When the BET switch 23 is pressed twice, in addition to the three paylines described above, the payline L1 for awarding the first prize, the payline L4 for awarding the fourth prize, and the payline L8 for awarding the eighth prize are set active, for example, and two coins are taken in as the credit medals.

When the BET switch 23 is pressed three times, in addition to the six paylines described above, the payline L2 for awarding the second prize, the payline L6 for awarding the sixth prize, and the payline L9 for awarding the ninth prize are set active, for example, and three coins are taken in as the credit medals.

The game that can be executed in the present embodiment is the basic game for aligning symbols along the payline. A transition to the second game using the coins entered in the basic game will be made at a timing when a prescribed condition is realized in the basic game.

The payout amount display unit 48 is for displaying the payout amount of coins when a combination for awarding a prize is realized along the payline. The credit amount display unit 49 is for displaying the credit amount of coins that are stored in the slot machine 13. The BET number display unit 50 is for displaying the BET number, i.e., the number of coins bet on the payline. The various display units 48 to 50 are formed by including 7 segment display device. Alternatively, the various display units 48 to 50 may be made to display images on the transparent liquid crystal panel 34. In the present embodiment, the exemplary case of the slot machine 13 using the mechanical reels 3A to 3E which are visible through the transparent liquid crystal panel 34 is described, but without being limited to the transparent liquid crystal panel 34, it is also possible to use virtual reels to be displayed on the liquid crystal display 30.

FIG. 5 and FIG. 6 are diagrams showing a configuration of the liquid crystal display 30 of the slot machine 13. The liquid crystal display 30 displays game images regarding the basic game and the second game. For this purpose, the liquid crystal display 30 has the front panel 31 having a touch panel 32 and a display plate 33, the transparent liquid crystal panel 34, a light guiding plate 35, a reflection film 36. fluorescent lamps 37a, 37b, 38a and 38b which are the so called white light sources, lamp holders 39a. 39b, 39c, 39d, 39e, 39f, 39g and 39h, and a table carrier package (TCP) on which the transparent liquid crystal panel driving IC is mounted. Although not particularly shown in FIG. 5 and FIG. 6, the TCP is formed by a flexible substrate (not shown) or the like which is connected to a terminal portion of the transparent liquid crystal panel 34.

The liquid crystal display 30 is provided on a front side of the display region of the mechanical reels 3A to 3E (a front side of the display screen 31a). The mechanical reels 3A to 3E and the liquid crystal display 30 are provided with a prescribed interval therebetween.

The touch panel 32 is formed by transparent elements. The display plate 33 is formed by transparent elements, and design patterns are formed at corresponding positions on the display plate 33 in a region between it and the various display units 48 to 50. Namely, a region on which the design patterns of the display plate 33 are formed is the design pattern formation region 31b in the front panel 31, and a region on which the design patterns of the display plate 33 are not formed is the display screen 31a in the front panel 31 (see FIG. 4). Alternatively, it is possible to make the entire front panel 31 as the display screen 31a without forming the design pattern formation region 31b in the front panel 31. In this case, either the design patterns are not formed on the display plate 33 or the display plate 33 is omitted.

Note that, in FIG. 5 and FIG. 6, electric circuits and the like for operating the various display units 48 to 50 that are arranged on the back side of the display plate 33 are not shown.

The transparent liquid crystal panel 34 is formed by inserting liquid crystal into a gap portion between a transparent substrate such as a glass plate or the like on which a thin film transistor layer is formed, and another transparent substrate facing against that transparent substrate. The display mode of the transparent liquid crystal panel 34 is set to be normally white. The normal white indicates that it becomes a white display (in which lights transmitting to the display screen side are visible from the outside) in a state where the liquid crystal is not activated. By adopting the transparent liquid crystal panel 34 that is set to be normally white in this way, even in the case where the situation where the liquid crystal cannot be activated occurs, the scrolling display and the stopping display of the symbols on the mechanical reels 3A to 3E can be made visible. For this reason, the player can continue the game. Namely, even in the case where the situation such as that described above occurs, it is still possible to play the game centered around the rearrangement of the symbols on the mechanical reels 3A to 3E.

The light guiding plate 35 is for guiding the lights from the fluorescent lamps 37a and 37b to the transparent liquid crystal panel 34 (in other words, for illuminating the transparent liquid crystal panel 34). The light guiding plate 35 is provided on the back side of the transparent liquid crystal panel 34, and formed by a transparent element (having a light guiding function) of acrylic resin or the like having a thickness of about 2 cm, for example.

The reflection film 36 is for reflecting the lights guided by the light guiding plate 35 toward the front side of the light guiding plate 35. The reflection film 36 is a white polyester film or aluminum thin film with a silver vaporization film formed thereon. The reflection film 36 is formed by a reflective region 36A and a non-reflective region (transmitting region) 36B The non-reflective region 36B is formed by a transparent material, and provided in a region containing a portion for covering a front side of the mechanical reels 3A to 3E in the front panel 31.

The fluorescent lamps 37a and 37b are arranged along an upper end portion and a lower end portion of the light guiding plate 35, and their both ends are supported by the lamp holders 39a and 39b, 39g and 39h, respectively. The lights emitted from the fluorescent lamps 37a and 37b are reflected by the reflective region 36A of the reflection film 36 and will illuminate the transparent liquid crystal panel 34. The fluorescent lamps 38a and 38b are arranged toward the mechanical reels 3A to 3E at an upper position and a lower position on the back side of the reflection film 36, and their both ends are supported by the lamp holders 39c and 39d, 39e and 39f, respectively. The lights emitted from the fluorescent lamps 38a and 38b, reflected at the surfaces of the mechanical reels 3A to 3E and entered into the non-reflective region 36B will illuminate the transparent liquid crystal panel 34. In this way, in the liquid crystal display 30, the light emitted from the fluorescent lamps 37a and 37b and reflected by the reflective region 36A of the reflection film 36 and the lights emitted from the fluorescent lamps 38a and 38b, reflected at the surfaces of the mechanical reels 3A to 3E and entered into the non-reflective region 36B will illuminate the transparent liquid crystal panel 34. Consequently, a region of the liquid crystal display 30 corresponding to the non-reflective region 36B of the reflection film 36 becomes a region which can be switched between transparent/non-transparent states according to whether the liquid crystal is activated or not. On the other hand, a region of the liquid crystal display 30 corresponding to the reflective region 36A of the reflection film 36 is in a non-transparent state regardless of whether the liquid crystal is activated or not.

In the slot machine 13, only one region of the display screen 31a of the liquid crystal display 30 is set as a region that can be switched between the transparent/non-transparent states, but it is also possible to set the entire region of the display screen of the liquid crystal display 30 as a region that can be switched between the transparent/non-transparent states. In the case of setting the entire region of the liquid crystal display 30 as a region that can be switched between the transmissive/non-transmissive states in this way, the reflection film 36 is entirely formed by the non-reflective region 36B or the reflection film 36 is omitted.

FIG. 7 is a block diagram showing an electric configuration of the controller 100 in the slot machine 13. As shown in FIG. 7, the controller 100 of the slot machine 13 is a micro-computer, which has an interface circuit group 102, an input/output bus 104, a CPU 106, a ROM 108, a RAM 110, a communication interface circuit 111, a random number generator 112, a motor driving circuit 120, a speaker driving circuit 122, a hopper driving circuit 124, a display unit driving circuit 128, and a display/input controller 140.

The interface circuit group 102 is connected to the input/output bus 104. The interface circuit group 102 carries out the input/output of data signals or address signals with respect to the CPU 106 through the input/output bus 104.

To the interface circuit group 102, the start switch 25 is connected. The start signal outputted from the start switch 25 is converted into a prescribed signal at the interface circuit group 102, and then supplied to the input/output bus 104.

To the interface circuit group 102, the BET switch 23, the spin/repeat/bet switch 24, and the cashout switch 26 are connected. Each switching signal outputted from any of these switches 23, 24 and 26 is converted into a prescribed signal at the interface circuit group 102, and then supplied to the input/output bus 104.

To the interface circuit group 102, a coin sensor 43 is connected. The coin sensor 43 is a sensor for detecting the coin entered into the coin slot 22, which is provided in relation to the coin slot 22. The sensing signal outputted from the coin sensor 43 is converted into a prescribed signal at the interface circuit group 102, and then supplied to the input/output bus 104.

To the interface circuit group 102, a reel position detection circuit 46 is connected. The reel position detection circuit 46 is a circuit for detecting a rotation position of each one of the mechanical reels 3A to 3E according to pulse signals from a reel rotation position sensors (not shown). The detection signal from this reel position detection circuit 46 is converted into a prescribed signal at the interface circuit group 102, and then supplied to the input/output bus 104.

To the input/output bus 104, the ROM 108 and the RAM 110 are connected.

The CPU 106 reads out the basic game program and executes the basic game, at a timing when the basic game start operation by the start switch 25 is accepted. The basic game program is programmed such that the scrolling of symbols of the reels 3A to 3E is started by rotating all the mechanical reels 3A to 3E by activating the stepping motors 45A to 45E, and after that, symbols of the reels 3A to 3E are rearranged by stopping the rotation of all the mechanical reels 3A to 3E by stop activating the stepping motors 45A to 45E, and when a combination of symbols stopped at that point is shown on the payline and it is a specific combination awarding a prize, coins according to the specific combination awarding a prize will be paid.

The controller 100 including the CPU 106 also controls the second game. The controller 100 including the CPU 106 performs a control to send a signal (hereinafter, referred to as a second game starting request signal) requesting execution start of the second game upon a predetermined condition being established when symbols of all the mechanical reels 3A to 3E are stopped and displayed. When the controller 100 receives from the center controller 14 a signal indicating that execution of the second game is allowed after sending the second game starting request signal, the controller 100 causes the liquid crystal display 30 displaying a screen of the basic game to display that the second game is executable.

When receiving from the center controller 14 a second game starting signal indicating the start of the execution of the second game after sending the second game starting request signal, the controller 100 including the CPU 106 causes the liquid crystal display 30 to display a small window showing that the second game is executable.

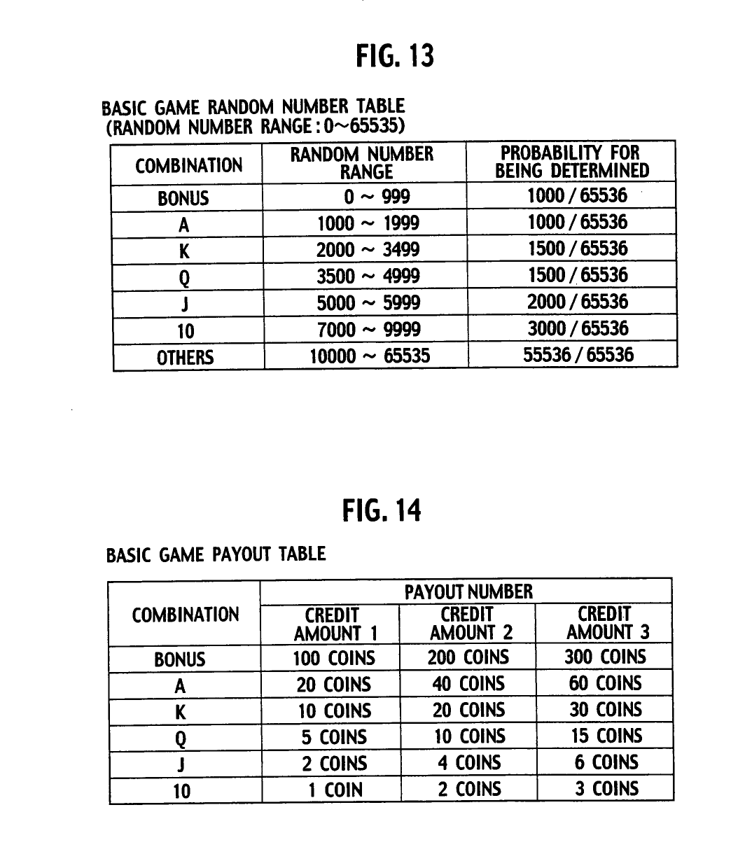

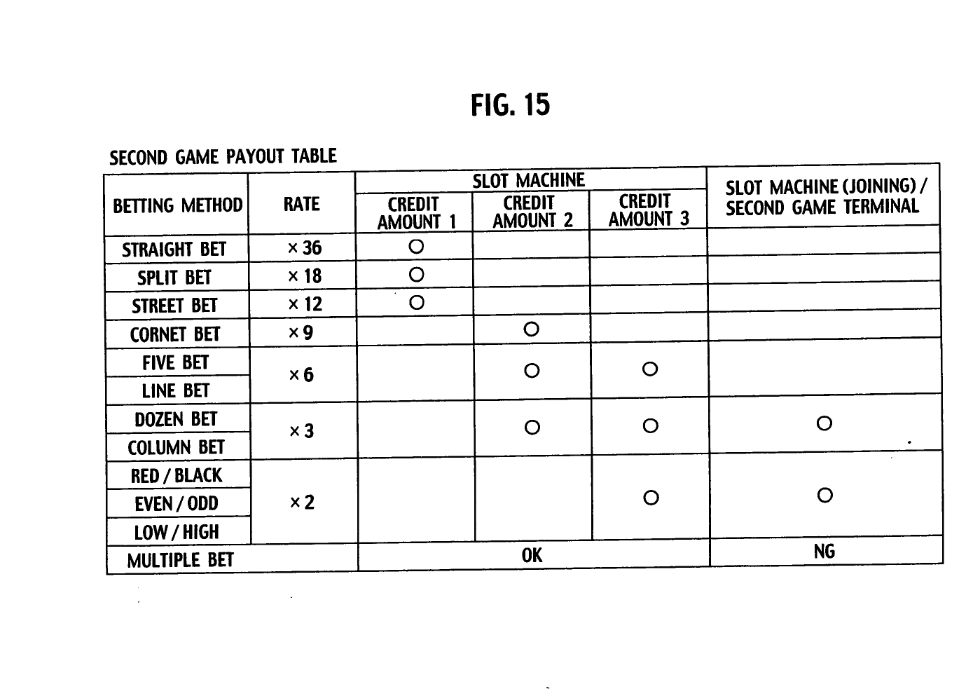

In the ROM 108, a control program for controlling the slot machine 13 collectively, a program for executing routines shown in FIG. 16 to FIG. 19 (hereafter referred to as a routine execution program), initial data for executing the control program, and various data tables to be used in the determination processing are stored. The routine execution program contains the above described basic game program and the like. The data tables include tables shown in FIG. 13 and FIG. 14 and the like. The RAM 110 temporarily stores values of flags and variables such as a simplified BET screen display flag to be described below which is used by the above described control program and the like.

To the input/output bus 104, the communication interface circuit 111 is connected. The communication interface circuit 111 is a circuit for carrying out communications with the center controller 14 and the other slot machines 13 and the like through the network (see FIG. 1) including various networks of LAN. In this embodiment, while the basic game is being in play, the CPU 106 makes a transition to the second game upon a predetermined condition being established. At this time, via the communication interface circuit 111, the CPU 106 sends the second game starting request signal, second game starting signal, and the like to the center controller 14 or receives the second game waiting signal, second game starting signal, and the like from the center controller 14.

The CPU 106 receives the data necessary for displaying the BET screen 70 from the center controller 14 via the communication interface circuit 111, and displays them as the image of the BET screen 70 on the liquid crystal display 30. After that, the liquid crystal display 30 functions as a terminal for the slot machine 13 to carry out the betting operation in the second game.

To the input/output bus 104, the random number generator 112 for generating random numbers is connected. The random number generator 112 generates a random number contained in a certain range of numerical values, “0” to “65535 (216-1)”, for example. Alternatively, it is possible to use a configuration in which a random number is generated by the calculation processing of the CPU 106.

To the input/output bus 104, the motor driving circuit 120 for driving the stepping motors 45A to 45E and the display unit driving circuit 120 for driving the various display units 48 to 50 are connected. The CPU 106 controls the operations of the various display units 48 to 50 and the stepping motors 45A to 45E through the motor driving circuit 120 and the display unit driving circuit 128, in response to an occurrence of a prescribed event.

To the input/output bus 104, the speaker driving circuit 122 for driving the speaker 41 is connected. The CPU 106 reads out the sound data stored in the ROM 108, and transmits the read out sound data to the speaker driving circuit 122 through the input/output bus 104. In this way, the prescribed effect sounds will be generated from the speaker 41.

To the input/output bus 104, the hopper driving circuit 124 for driving the hopper 44 is connected. When the cashout signal from the cashout switch 26 is inputted, the CPU 106 outputs the driving signal to the hopper driving circuit 124 through the input/output bus 104. In this way, the hopper 44 will pay out coins corresponding to the remaining credit amount at that timing that is stored in a prescribed memory region of the RAM 110.

To the input/output bus 104, the display/input controller 140 is connected. The CPU 106 generates image display commands according to a game state and a game result, and outputs the generated image display commands to the display/input controller 140 through the input/output bus 104. When the image display commands from the CPU 106 are inputted, the display/input controller 140 generates the driving signals for driving the liquid crystal display 30 according to the inputted image display commands, and outputs the generated driving signals to the liquid crystal display 30. In this way, the prescribed images are displayed on the transparent liquid crystal panel 34 of the liquid crystal display 30. The display/input controller 140 transmits signals inputted by the touch panel 32 on the liquid crystal display 30 to the CPU 106 through the input/output bus 104, as the input signals.

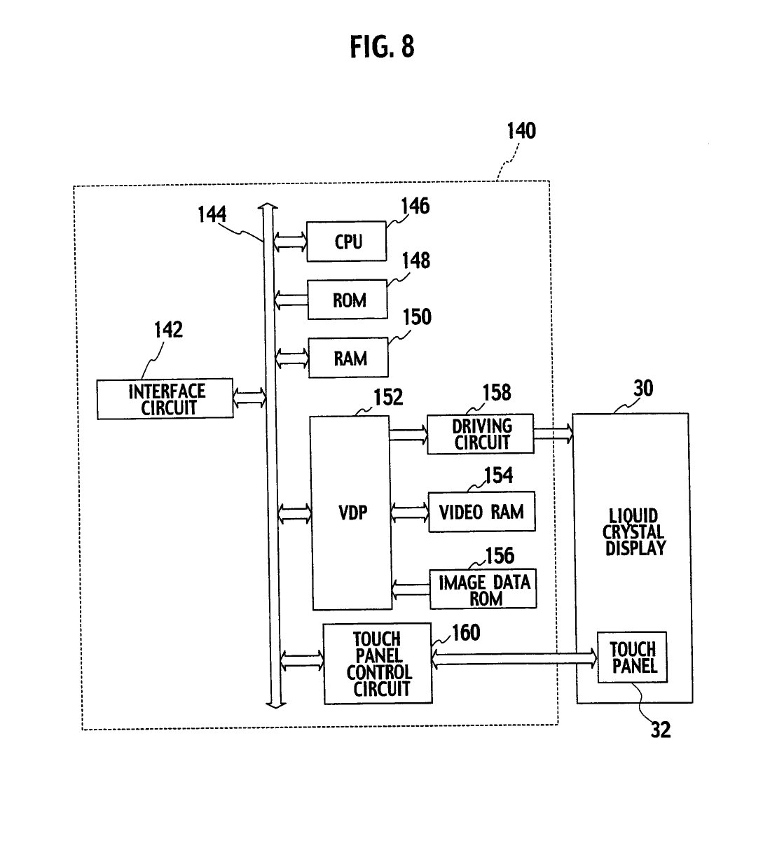

FIG. 8 is a block diagram showing an electric configuration of the display/input controller 140 in the slot machine 13. The display/input controller 140 of the slot machine 13 is a sub micro-computer for controlling inputs from the image display processing and the touch panel 32. The display/input controller 140 has an interface circuit 142, an input/output bus 144, a CPU 146, a ROM 148, a RAM 150, a VDP 152, a video RAM 154, an image data ROM 156, a driving circuit 158 and a touch panel control circuit 160.

The interface circuit 142 is connected to the input/output bus 144. The image display commands outputted from the CPU 106 of the controller 100 side are supplied to the input/output bus 144 through the interface circuit 142, and sent to the CPU 146. The input/output of data signals or address signals with respect to the CPU 146 is carried out through the input/output bus 144.

To the input/output bus 144, the ROM 148 and the RAM 150 are connected. In the ROM 148, a display control program is stored. This display control program is for generating driving signals to be supplied to the liquid crystal display 30 according to the image display commands from the CPU 106 of the controller 100 side. On the other hand, in the RAM 150, values of flags and variables to be used in the above described display control program are stored.

To the input/output bus 144, the VDP 152 is connected. The VDP 152 is a processing device containing the so called sprite circuit, screen circuit and palette circuit, which can carry out various processings for the purpose of displaying images on the liquid crystal display 30. To the VDP 152, the video RAM 154 for storing the image data according to the image display commands from the CPU 106 of the controller 100 side and the image data ROM 156 for storing various types of image data including the above described effect image data and the like are connected. To the VDP 152, the driving circuit 158 for outputting the driving signals for driving the liquid crystal display 30 is connected.

The CPU 146 stores the image data to be displayed on the liquid crystal display 30 according to the image display commands from the CPU 106 of the controller 100 side into the video RAM 154, by reading and executing the display control program stored in the ROM 148. The image display commands include various types of image display commands such as display commands for the above described effect images.

The image data ROM 156 stores various types of image data including data of the above described effect images and the like.

The touch panel control circuit 160 transmits signals inputted by the touch panel 32 on the liquid crystal display 30 to the CPU 106 through the input/output bus 144, as the input signals.

FIG. 9 shows a plan view of the second game device 11. As shown in FIG. 9, the second game device 11 mainly comprises a roulette device 60, and a display 69 for displaying the BET screen 70 formed by the betting board 70 and the like. The roulette device 60 basically comprises a frame body 61 fixed to the second game device 11, and a wheel 62 contained and supported to be rotatable within the frame body 61. On the upper face of the wheel 62, a multiplicity (38 in the present embodiment) of concave shaped number pockets 63 are formed. On the upper face of the wheel 62 at the outward direction of the number pockets 63, number display plates 64 displaying numbers “0”, “00”, “1” to “36” as numerical figures are formed in correspondence to the number pockets 63. A total 38 of the number pockets 63 with each assigned with any one number among “0”, “00”, “1” to “36” are formed on the wheel 62.

Inside the frame body 61, a ball entry port 68 is formed. The ball entry port is connected with a ball entering device (not shown), such that a ball 65 is entered onto the wheel 62 from the ball entry port 68, in conjunction with the driving of the ball entering device. Also, the entire upper side of the roulette wheel is covered by a hemispherical cover element 67 made of a transparent acrylic material (see FIG. 2).

On the lower side of the wheel 62, a win judgment device (not shown) is provided. This win judgment device is a device for judging which number pocket 63 accommodated the ball 65. On the lower side of the wheel 62, a ball collecting device (not shown) is provided. This ball collecting device is a device for collecting the ball 65 on the wheel 62. The ball entering device, the win judgment device, and the ball collecting device are already well known so that their detailed descriptions will be omitted here.

The frame body 61 is gently sloping toward inside, and a guide wall 66 is formed on its middle portion. The guide wall 66 is for keep rolling the ball 65 by guiding the entered ball 65 against the centrifugal force. Then, as the rotational speed of the ball 65 drops and the centrifugal force becomes weak, the ball 65 rolls down the slope of the frame body 61 toward inside and reaches to the rotating wheel 62.

Then, the ball 65 that rolled to the wheel 62 is accommodated into any one of the number pockets 63 by passing over the number display plates 64 on the outer side of the rotating wheel 62. As a result, the number described in the number display plate 64 corresponding to the number pocket 63 that accommodated the ball 65 is judged by the win judgment device, and that number becomes the winning number.

On the other hand, the display 69 for displaying the BET screen 70 having the betting board 71 is formed by a liquid crystal display, for example. When the players bet chips by using the owned credits by operating the slot machines 13 and the second game terminals 15 as described below, the bet chips will be displayed. The game medium such as coins in the slot machines 13 and the second game terminals 15 will be credited as chips in the roulette game. In the present embodiment, the BET screen 70 is displayed by the display 69, but it may be displayed by a projector or the like provided vertically downward from a ceiling, by changing the display 69 to a screen. In this case, it is possible to expect the more realistic display as it becomes possible to display the bet chips three dimensionally, by using the known technology.

On the betting board 71 displayed on the BET screen 70 of the display 69, the same numbers as 38 types of numbers “0”, “00” and “1” to “36” are arranged and displayed in a lattice shaped grids. BET areas 73 for betting chips by specifying “odd numbers”, “even numbers”, “a color of the number display plate 64 (red or black)”, or “a range of numbers (“1” to “12”, for example)” are similarly arranged in a lattice shaped grids.

On the left side of the betting board 71, a result log display unit 72 is displayed. The result log display unit 72 displays a list of the resulting winning numbers in the previous games (here, one game is a series of operations in which the players make bets at the slot machines 13 and the second game terminals 15, the ball 65 drops into the number pocket 63, and the payout of credit is made according to the winning number). When one game is finished, a new winning number is added from the above and displayed, and it is made possible to check the log of the winning numbers of at most 16 games.

On the BET areas 73 (on the grids of the numbers and the marks or on lines forming grids), the bet chips are displayed when the players bet chips by using the slot machines 13 and the second game terminals 15.

On the upper portion of the betting board 71, a BET time display unit 74 is provided. The BET time display unit 74 displays a remaining time in which the players can bet. In the present embodiment, “30” will be displayed at a time of start accepting the betting operation, this number is decremented by one per each second, and the acceptance of the betting operation is finished when this number becomes “0”. When the remaining time for betting by the players at the slot machines 13 and the second game terminals 15 becomes five seconds, the ball entering device is activated and the ball 65 is entered onto the roulette wheel.

Furthermore, on the right of the BET time display unit 74, a JP display unit 75 displaying the number of credits which have been accumulated in a jackpot (hereinafter, referred to as a JP) is provided. The JP display unit 75 displays the amount to which 0.5% of credits among the credits bet at a total 12 locations of the slot machines 13 and the second game terminals 15 are accumulated. Then, when a prescribed condition is realized by a JP bonus game which occurs at a prescribed timing, it becomes the win of JP. Then, the credit amount of JP is paid out, and the JP display unit 75 for the paid out JP will display a numerical value of an initial value (50,000 credits, for example).

On the betting board 71, chip marks 76 for indicating the number of chips and the BET area 73 that are bet until that time are displayed. The number displayed on the chip mark 76 indicates the number of bet chips. For example, as shown in FIG. 9, the chip mark 76 of “1” placed at an intersection of grids “5”, “6”, “8” and “9” indicates that it covers four numbers of “5”, “6”, “8” and “9” and one chip is bet. A method for betting that covers four numbers in this way is a betting method called “corner bet”.

The chip mark 76 of “20” placed on a grid “2to1” indicates that it covers 12 numbers of a column of “1”, “4”, “7”, and so one, and 20 chips are bet. A method for betting that covers 12 numbers by using a grid written as “2to1” in this way is abetting method called “column bet”.

The other betting methods include a “straight bet” for betting only on one number, a “split bet” for covering two numbers by betting on a line between two numbers, a “street bet” for covering three numbers (“13”, “14” and “15”, for example) by betting at an edge of one row of numbers (one column in a vertical direction in FIG. 9), a “five bet” for covering five numbers “0”, “00”, “1”, “2” and “3” by betting on a line between “00” and “3”, a “line bet” for covering six numbers (“13”, “14”, “15”, “16”, “17” and “18”, for example) by betting between numbers of two rows (two columns in a vertical direction in FIG. 9), and a “dozen bet” for covering 12 numbers by betting on a grid written as “1st12”, “2nd12” or “3rd12”. In addition, there are “red/black” for betting on the color of the number display plate 64 (“red” or “black”), “even/odd” for betting on the odd numbers or the even numbers, and “low/high” for covering 18 numbers by betting on the numbers less than or equal to 18 or the numbers greater than or equal to 19. Here, these plurality of betting methods have different payout amounts of credit per one chip (payout rates) when the bet chips win.

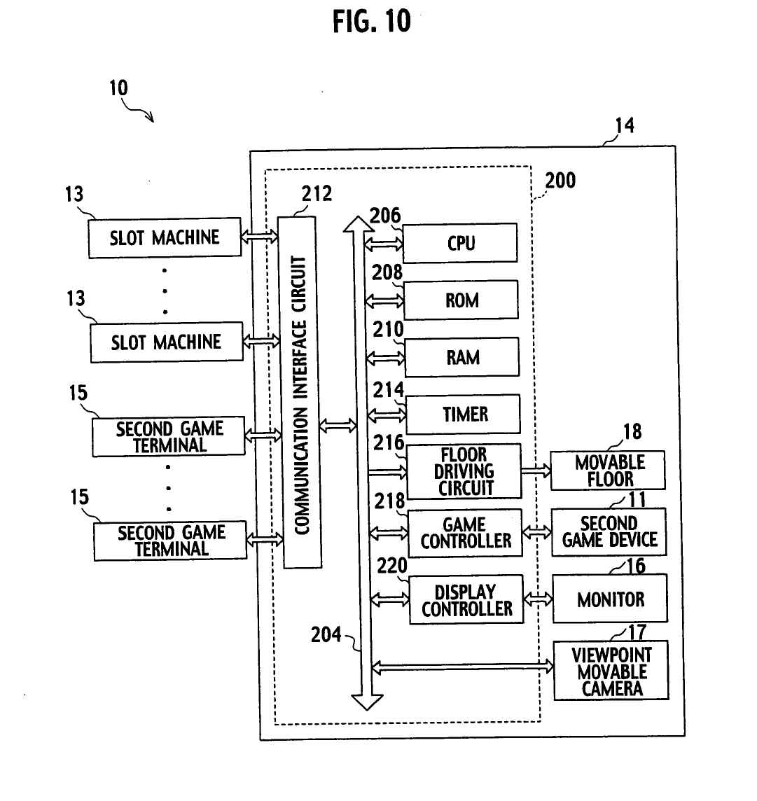

FIG. 10 is a block diagram showing an electric configuration of a controller 200 in the center controller 14. As shown in FIG. 10, the center controller 14 comprises a controller 200 and several peripheral devices. The center controller 14 is connected to a plurality (eight in the present embodiment) of the slot machines 13, a plurality of (four in the present embodiment) of the second game terminals 15 and the monitor 16 (display) through a communication interface circuit 212.

The controller 200 has an input/output bus 204, a CPU 206, a ROM 208, a RAM 210, a communication interface circuit 212, a timer 214, a floor driving circuit 216, a game controller 218, and a display controller 220.

To the input/output bus 204, the ROM 208 and the RAM 210 are connected.

The CPU 206 carries out various types of processing according to input signals and the like supplied from the slot machines 13 and the second game terminals 15 and data and programs stored in the ROM 208 and the RAM 210, and transmits command signals to the slot machines 13 and the second game terminals 15 according to that result. In this way, the controller 200 containing the CPU 206 controls the slot machines 13 and the second game terminals 15 by its initiative, and proceeds with the game.

The center controller 14 includes the configuration of the controller 200 and can perform a control to cause the second game device 11 to start the second game for the slot machine which has got a right to execute the second game and sent the second game starting request signal when the center controller 14 receives the second game starting request signal from at least one of the plurality of slot machines 13 and a predetermined start condition is established.

Herein, the predetermined start condition is that: the execution of the second game is determined to start by a process to determine whether to start execution of the second game; the number of slot machines determined to start the second game by the process to determine whether to start the second game has reached a certain number; or a predetermined one of the slot machines 13 is determined to start the second game in the process whether to start execution of the second game.

As one of the start condition, the center controller 14 executes a control to determine whether to start execution of the second game when receiving each second game starting request signal and performs a control to cause the second game device to start the second game for the slot machine determined to start the second game. Such an example is described using FIGS. 17A to 17C. This is a first mode of the basic game and second game executed in the game system 10 of the present invention.

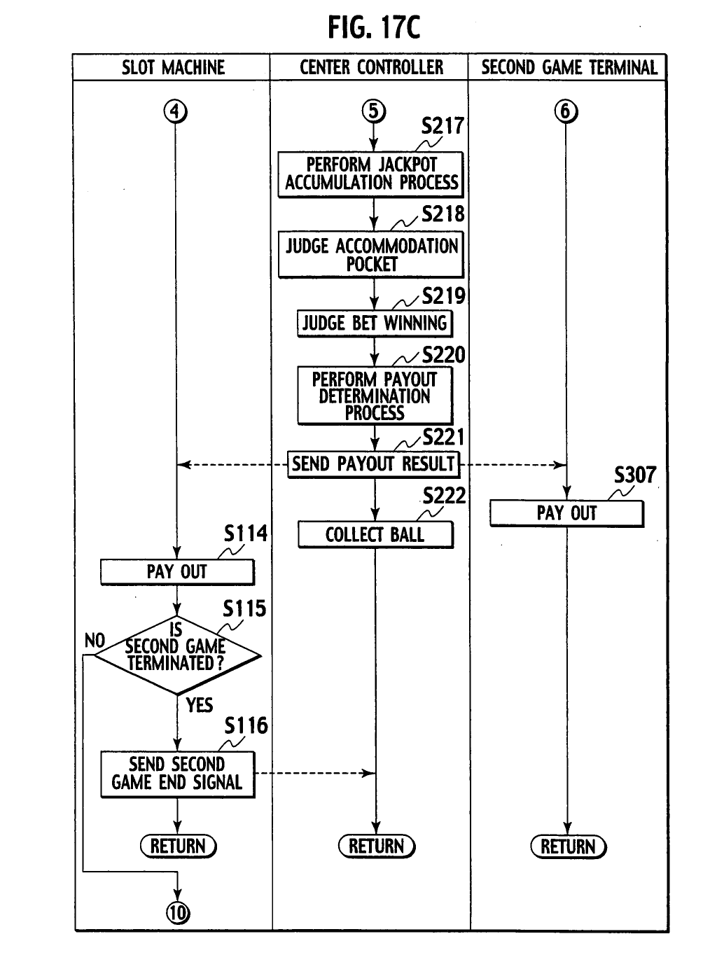

As another one of the start condition, the center controller 14 executes a control to determine whether to start the second game when the center controller 14 receives each second game starting request signal and the number of slot machines determined to start the second game has reached a certain number, the center controller 14 performs a control to cause the second game device to start the second game for the certain number of slot machines determined to start the second game. Such an example is described using FIG. 18. This is a second mode of the basic game and second game executed in the game system 10 of the present invention.

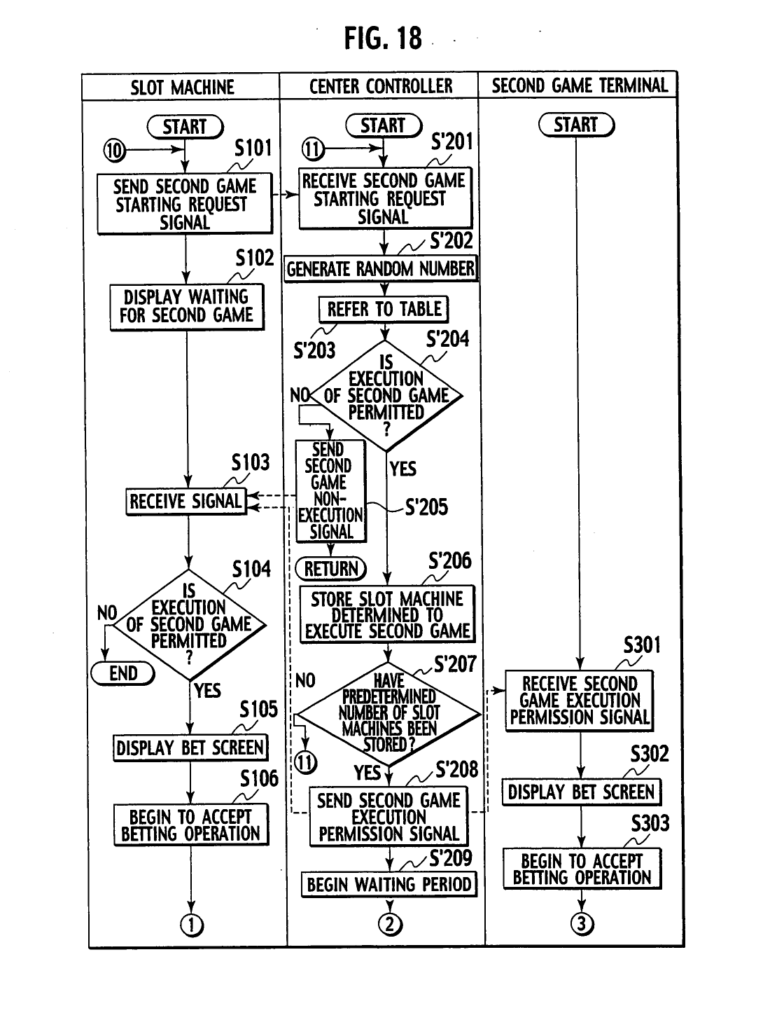

As still another one of the start condition, the center controller 14 executes a control to determine whether to start execution of the second game when receiving each second game starting request signal, and the center controller 14 performs a control to cause the second game device to start the second game when a predetermined one of the slot machines 13 each having sent the second game starting request signal is determined to start the second game. Such an example is described using FIG. 19. This is a third mode of the basic game and second game executed in the game system 10 of the present invention.

The input/output bus 204 is connected to the second game device 11 through the game controller 218. When the second game starting signal is received in return from the slot machine 13 to which the second game starting signal is transmitted, the controller 200 containing the CPU 206 controls the second game device 11 to start the second game. More specifically, by activating the driving motor (not shown) provided in the roulette device 60 of the second game device 11, the shooting of the ball 65 and the rotation of the wheel 62 are carried out, and the win judgment device for identifying the falling position of the ball 65 is controlled. In this way, the winning number onto which the ball 65 has fallen is judged. Then, the win judgment for the bet chips is made according to the obtained winning number and the betting information transmitted from the slot machines 13 and the second game terminals 15, and the payout amount of credit to be paid at each of the slot machines 13 and the second game terminals 15 is calculated. The second game device 11 is connected to the controller 200 of the center controller 14 through the communication interface circuit 212, similarly as the slot machines 13 and the second game terminals 15.

Moreover, if the second game is in play when the controller 200 including the CPU 206 receives the second game starting request signals from the slot machines 13, as described later, the controller 200 stores the rights to make a transition to the second game in the second game transition right memory area of the RAM 210 in the order that the controller 200 has received the rights. The controller 200 then sends the second game waiting signal to each slot machine 13 which has sent the second game starting request signal.

Furthermore, when the second game ends and allows another slot machine 13 to make a transition to the second game, the controller 200 including the CPU 206 reads the right to make a transition to the second game from the top of the second game transition right memory area and sends the second game execution permission signal to the slot machine 13 having the read right. When receiving the second game starting signal in return from the slot machine which the controller 200 has sent the second game execution permission signal, the controller 200 performs a control to cause the second game device 11 to start the second game. The subsequent process is the same as that described above.

The ROM 208 comprises a semiconductor memory or the like, for example, and stores a program for realizing basic functions of the second game device 11, a program for realizing functions of the viewpoint movable cameras 17, a program for controlling the slot machines 13 and the second game terminals 15 by its initiative, etc. The programs include a program shown in FIG. 17A to 17C. It also stores the payout rates (the payout amounts of credit for a win per one chip) for the roulette game.

More specifically, in the ROM 208, a payout credit memory area (not shown) which stores the payout rates regarding the roulette game using the BET screen 70 is provided, and a second game payout table as shown in FIG. 15 to be described below is stored. As the payout rates for BET areas 73 of the BET screen 70 stored in the payout credit memory area, the rates of “2 times” to “36 times” are determined in advance according to types of the betting method (“straight bet”, “corner bet”, “split bet”, etc.) and stored.

On the other hand, the RAM 210 temporarily stores the chip betting information supplies from the slot machines 13 and the second game terminals 15, the winning number of the roulette device judged by the sensor, the amount of JP accumulated until now, and data regarding the result of the processing executed by the CPU 206, etc.

The RAM 210 stores the rights to make a transition to the second game of the slot machines 13 in an order of receiving the second game starting request signal. More specifically, the information regarding the rights to make a transition to the second game is maintained in a queue, and managed such that the information stored first will be read out first. Namely, when the currently executed second game is finished and a transition to the next second game becomes possible, one right to make a transition to the second game maintained in the queue at a top will be read out.

Specifically, the RAM 210 includes a betting information memory area storing betting information of a player currently playing; a winning number memory area storing a winning number of the roulette machine 60 determined by a winning determination machine; a JP accumulation memory area (not shown) storing the number of credits calculated by accumulating 0.5% of the number of credits bet in the BET screen 70 (see FIG. 9); and a second game transition right memory area (not shown) sequentially storing rights to make a transition to the second game. More specifically, the betting information is an information regarding the bets made by using the slot machines 13 and the second game terminals 15 such as the BET area 73 specified in the BET screen 70, the number of chips bet (bet number), and the type of the betting method. As the information regarding the right to make a transition to the second game, the data for specifying the slot machine 13 which transmitted the second game starting request signal (such as an address or an ID on a network, for example) can be used.

To the input/output bus 204, the timer 214 for measuring time is connected. The time information of the timer 214 is transmitted to the CPU 206 via the input/output bus 204, and the CPU 206 carries out the rotation operation of the wheel 62 and the entering of the ball 65 as will be described below, according to the time information of the timer 214.

To the input/output bus 204, the floor driving circuit 216 is connected. The CPU 206 carries out a control to raise the movable floor 18 through the floor driving circuit 216, in response to receiving the signal for starting the second game from the slot machine 13. The CPU 206 carries out a control to lower the movable floor 18 through the floor driving circuit 216 in response to receiving a signal for finishing the second game from the slot machine 13.

To the input/output bus 204, the viewpoint movable cameras 17 are connected. The CPU 206 carries out various types of processing according to data and programs stored in the ROM 208 and the RAM 210, controls the viewpoint movable cameras 17 according to that result so as to take images.

FIG. 11 is a diagram showing the second game terminal 15. As shown in FIG. 11, the second game terminal 15 at least has a coin slot 91 for entering the game medium such as coins, a control unit 92 formed by a plurality of control buttons and the like by which prescribed commands will be inputted by the player, and a display 93 for displaying images related to the game. The display 93 also plays a role of accepting the betting operation of the player. Then, the as the player operates the touch panel 99 and the control unit 92 while watching the images displayed on the display 93, the game in developing can be proceeded. The game medium to be used in the second game terminal 15 is also not limited to coins.

On the side face of the cabinet 90 in which the second game terminal 15 is arranged, a coin tray 94 is provided. In addition, on the upper right side of the display 93 of the second game terminal 15, a speaker 95 for outputting music, effect sounds and the like is provided.

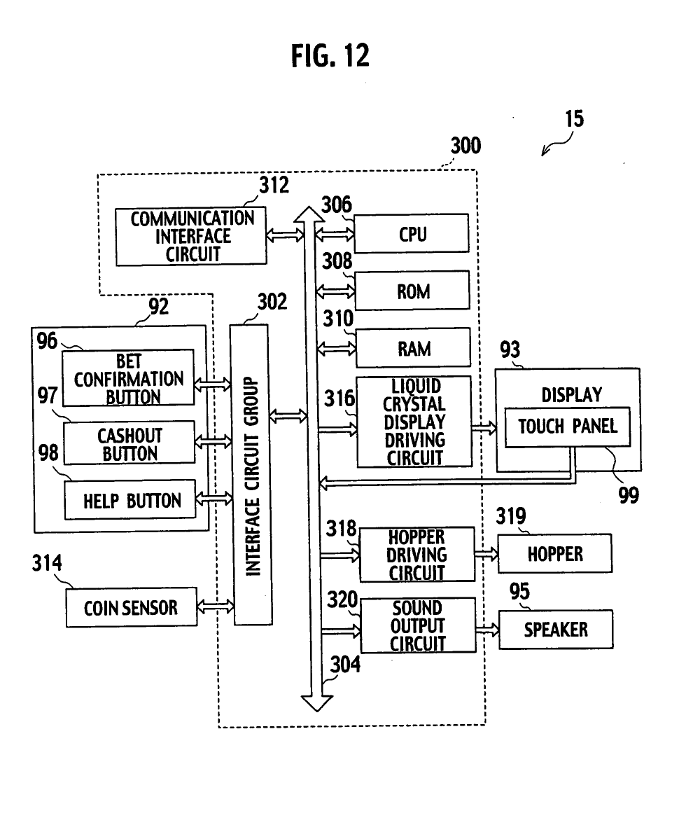

Inside the coin slot 91, a coin sensor 314 (see FIG. 12) is provided, which carries out the identification of the game medium such as coins entered from the coin slot 91, and counts the entered coins. Inside the coin tray 94, a hopper 319 (see FIG. 12) is provided, which pays out a prescribed number of coins from the coin tray 94.

In this way, by using the touch panel 99 of the second game terminal 15, the operation performance of the player is made easier. As a result, it becomes possible for a third person of the gaming facility to join the roulette game by using the second game terminal 15 lightheartedly.

FIG. 12 is a block diagram showing an electric configuration of a controller 300 in the second game terminal 15. As shown in FIG. 12, the second game terminal 15 comprises a controller 300 of the second game terminal 15 and several peripheral devices.

The controller 300 has an interface circuit group 302, an input/output bus 304, a CPU 306, a ROM 308, a RAM 310, a liquid crystal driving circuit 316, a hopper driving circuit 318 and a sound output circuit 320.

The interface circuit group 302 is connected to the input/output bus 304. The input/output of the data signals or the address signals with respect to the CPU 306 is carried out through the input/output bus 304.

To the interface circuit group 302, a BET confirmation button 96, a cashout button 97 and a help button 98 that are provided in the control unit 92 (see FIG. 11) are connected. The operation signal outputted from each of these buttons is converted into a prescribed signal at the interface circuit group 302 and then supplied to the input/output bus 304. The CPU 306 carries out a control to execute various corresponding operations according to the operation signals supplied from the input/output bus 304 which are outputted by the pressing of these buttons.

To the interface circuit group 302 connected through the input/output bus 304, the coin sensor 314 is connected. The coin sensor 314 detects the coins entered from the coin slot 91 (see FIG. 11), counts the entered coins, and transmits that result to the CPU 306. Then, the CPU 306 increases the credit amount owned by the player which is stored in the RAM 310, according to the transmitted signal.

To the input/output bus 304, the ROM 308 and the RAM 310 are connected.

The CPU 306 receives the command signals from the CPU 206 inside the controller 200 of the center controller 14, through the interface circuit group 312 connected to the input/output bus 304. Then, the CPU 306 controls the peripheral devices constituting the second game terminal 15 according to these command signals, and makes the roulette game proceeds on the second game terminal 15. The CPU 306 executes various types of processing according to the input signals supplied from the control unit 92, and data and programs stored in the ROM 308 and the RAM 310, upon receiving an input of the operation of the player, depending on the content of the processing. Then, according to that result, the prescribed signals and the like are transmitted to the CPU 206 inside the controller 200 of the center controller 14 via the interface circuit group 312, controls the peripheral devices constituting the second game terminal 15, and makes the roulette game proceeds on the second game terminal 15.

The ROM 308 comprises a semiconductor memory or the like, for example, and stores a program for realizing basic functions of the second game terminal 15, and various types of programs, data tables and the like that are necessary in controlling the second game terminal 15. The programs include a program shown in FIG. 17A to 17C. The RAM 310 temporarily stores various data calculated by the CPU 306, the credit amount (deposited in the second game terminal 15) currently owned by the player, the state of chips bet by the player, etc.

To the input/output bus 304, the hopper driving circuit 318 is connected. The hopper 319 connected through the hopper driving circuit 318 pays out a prescribed number of coins from the coin tray 94 (see FIG. 11), according to the command signal from the CPU 306.

To the input/output bus 304, the display 93 is connected through the liquid crystal driving circuit 316. The liquid crystal driving circuit 316 comprises a program ROM, an image ROM, an image control CPU, a work RAM, a VDP (Video Display Processor), and a video RAM, although these are not shown in the figure. Then, in the program ROM, the image control program regarding the display on the display 93 and various types of selection tables are stored. In the image ROM, the dot data for forming images to be displayed on the display 93 are stored, for example. The image control CPU determines the images to be displayed on the display 93 from the dot data stored in advance in the image ROM, according to the image control program stored in advance in the program ROM, based on the parameters set by the CPU 306. The work RAM is a temporary storage means at a time of executing the image control program at the image control CPU. The VDP forms images according to the display content determined by the image control CPU, and outputs them to the display 93. The video RAM is a temporary storage means at a time of forming images at the VDP.

On the front face of the display 93, the touch panel 99 is attached as described above. The operation information of the touch panel 99 is transmitted to the CPU 306 through the input/output bus 304. At the touch panel 99, the chip betting operation of the player is made in the BET screen 70 as shown in FIG. 25 to be described below which is displayed on the display 93. More specifically, the operation of the touch panel 99 is carried out in the selection of the BET area 73, the operation of the unit BET button 77 and the like to be described below, and that information is transmitted to the CPU 306. Then, according to that information, the betting information (the BET area 73 specified in the BET screen 70 and the number of chips bet) of the current player is stored into the RAM 310. In addition, that betting information is transmitted to the CPU 206 of the center controller 14, and stored into the betting information memory area of the RAM 210.

To the input/output bus 304, the sound output circuit 320 and the speaker 95 are connected, and the speaker 95 generates various types of effect sounds at a time of carrying out various types of effects according to the output signals from the sound output circuit 320.

FIG. 13 is showing a basic game random number table to be used by the basic game of the slot machine 13 which will be explained by FIG. 16 to be described below. In this basic game random number table, a range of random numbers and a winning probability are registered in correspondence for each specific combination for awarding a prize. For this reason, in the combination determination processing (step S5 of FIG. 16) to be described below, the generation of the specific combination for awarding a prize of “BONUS” as an eventual basic game result in a case where a random number in a range of “0” to “999” among random numbers of “0” to “65535” is extracted, for example, is determined inside the slot machine 13. In other words, the probability for having a combination of stopped symbols determined as the specific combination for awarding a prize of “BONUS” becomes “1000/65535”. Also, the generation of the specific combination for awarding a prize of “K” as an eventual basic game result in a case where a random number in a range of “2000” to “3499” among random numbers of “0” to “65535” is extracted, for example, is determined inside the slot machine 13. In other words, the probability for having a combination of stopped symbols determined as the specific combination for awarding a prize of “K” becomes “1500/65535”. On the other hand, the generation of a lost game as an eventual basic game result in a case where a random number in a range of “10000” to “65535” among random numbers of “0” to “65535” is extracted, for example, is determined inside the slot machine 13. In other words, the probability for having a combination of stopped symbols determined as a combination indicating a lost game becomes “55536/65535”.

FIG. 14 is showing a basic game payout table to be used in the basic game which will be explained by FIG. 16 to be described below. In this basic game payout table, the specific combination for awarding a prize and a number of coins to be paid for each credit amount bet in one game are registered in correspondence. For this reason, at a time of judging whether it is the specific combination for awarding a prize or not, in the case where the combination of “K” is generated, 10 coins will be paid when the BET credit amount is “1”, 20 coins will be paid when the BET credit amount is “2”, and 30 coins will be paid when the BET credit amount is “3”. For example, in the case where the combination of “BONUS” is generated, 100 coins when the BET credit amount is “1”, 200 coins when the BET credit amount is “2”, and 300 coins when the BET credit amount is “3”, will be transmitted to the center controller 14 as the credit data, and become usable as the credit in the second game to be described below.

FIG. 15 shows one example of a second game payout table to be used in the roulette game which will be explained by FIG. 17A to FIG. 17C to be described below. In this second game payout table, an allowed range of the betting methods and a presence/absence of an allowance for multiple bets are registered for each terminal. Here each terminal implies the following three cases. One is the slot machine 13 which made a transition to the roulette game as a combination for awarding a prize of “BONUS” is stopped and displayed on the payline (hereafter referred to as a main slot machine 13). Another one is the slot machine 13 which has not made a transition to the roulette game as a combination of “BONUS” is not stopped and displayed on the payline by this slot machine 13 itself but it joins the roulette game to be started by the main slot machine 13 (hereafter referred to as a joining slot machine 13). Still another one is the second game terminal 15.

The second game payout table is configured such that the allowed range of the betting methods is different according to the credit amount bet in the basic game when a combination for awarding a prize of “BONUS” is generated, for the main slot machine 13.

For example, in the case where the credit amount bet when a combination for awarding a prize of “BONUS” is generated in the main slot machine 13 is “1”, the betting methods by which the bet can be made in the roulette game are at least one of “straight bet”, “split bet”, and “street bet”. Namely, the multiple bets are allowed for the main slot machine 13. Consequently, “straight bet” may be made at a plurality of places, or both of “straight bet” and “split bet” may be made. The betting method by which the bet can be made in the roulette game by the joining slot machine 13 is one of “dozen bet”, “column bet”, “red/black”, “even/odd” and “low/high”. Namely, the multiple bets are not allowed for the joining slot machine 13, so that it can only bet at one place among the BET areas 73 of the BET screen 70 in the present embodiment.

FIG. 15 is only showing one example in the present embodiment, and the payout rate for each BET area 73 of the BET screen 70 stored in this payout credit memory area may be made to be different for the slot machines 13 and for the second game terminals 15. It may be made to be different for the main slot machine 13 and the joining slot machine 13 even among the slot machines 13.

In one example shown in FIG. 15, the limitation is put on the betting methods according to the credit amount bet in the basic game of the main slot machine 13, but besides that, it may be made to determine the rate according to the credit amount bet in the basic game of the main slot machine 13. It may be made to allow the use of coins of the slot machine 13 as additional credit at a time of playing the roulette game and change the rate according to the additional credit amount, or it may be made to change the rate according to the total betting amount.

As in the second game payout table shown in FIG. 15, the payout rate for the roulette game is set to be relatively high, so that a high payout can be expected depending on the betting method of the player.

FIG. 16 is a flow chart showing a flow of processing operations in the basic game to be executed by the controller 100 of the slot machine 13. This program will be executed by being called up at a prescribed timing from the main program of the slot machine 13 which is already being executed. The main program is a program for controlling overall operations of the slot machine 13.

In the following, it is assumed that the slot machine 13 is activated in advance, the variables to be used in the CPU 106 of the controller 100 side are initialized to prescribed values, and as a result the slot machine 13 is normally operating.

The CPU 106 of the controller 106 side judges whether the credit which is the remaining number of coins entered by the player is remaining or not (step S1). More specifically, the CPU 106 reads out the credit amount C stored in the RAM 110, and carries out the processing according to this read out credit amount C. In the case where the credit amount C is “0” (step S1 NO), the CPU 106 cannot start the game, so that it finishes this routine without carrying out any processing. On the other hand, in the case where the credit amount C is greater than or equal to “1” (step S1 YES), the CPU 106 judges that there is a remaining credit, and shifts the processing to the step S2.

When it is shifted to the step S2, the CPU 106 judges whether the pressing operation of the spin/repeat/bet switch 24 is carried out or not. In the case where the spin/repeat/bet switch 24 is pressed and the operation signal from the spin/repeat/bet switch 24 is inputted in conjunction with this (step S2 YES), the CPU 106 shifts the processing to the step S12. On the other hand, in the case where the operation signal from the spin/repeat/bet switch 24 is not inputted even after a prescribed time has elapsed (step S2 NO), the CPU 106 judges that the spin/repeat/bet switch 24 is not pressed, and shifts the processing to the step S3.

When it is shifted to the step S3, the game condition is set. More specifically, the CPU 106 determines the number of coins to be bet on the payline in this game, according to the operation of the BET switch 23. At this point, the CPU 106 receives the operation signal generated as the operation of the BET switch 23 is carried out, and stores the BET number regarding the payline into a prescribed memory region of the RAM 110 according to the number of times by which this received operation signal is received. The CPU 106 reads out the credit amount C written in a prescribed memory region of the RAM 110, subtracts the total BET number in which the above described BET number is added, from this read out credit amount C, and stores this subtracted value into a prescribed memory region of the RAM 110. After that, the CPU 106 shifts the processing to the step S4.

When it is shifted to the step S4, the CPU 106 judges whether the start switch 25 is ON or not, and waits for having the start switch 25 operated. In the case where the start switch 25 is operated and the operation signal from the start switch 25 is inputted in conjunction with this (step S4 YES), the CPU 106 judges that the start switch 25 is operated, and shifts the processing to the step S5.

On the other hand, when it is shifted to the step S12, the CPU 106 judges whether the value of the credit amount C is greater than or equal to the value of the total bet amount in the previous game or not. In other words, the CPU 106 judges whether it is possible to start the game as the spin/repeat/bet switch 24 is pressed. More specifically, when the spin/repeat/bet switch 24 is pressed and the operation signal from that switch 24 is inputted in conjunction with this, the CPU 106 reads out the credit amount C and the BET numbers regarding the paylines L1 to L9 in the previous game which are written in a prescribed memory region of the RAM 110, and carries out the processing according to whether the value of the credit amount C is greater than or equal to the value the total bet amount in the previous game or not, according to the relationship between the read out credit amount C and the BET numbers. In the case where it is judged that the value of the credit amount C is less than the value of the total bet amount in the previous game (step S12 NO), the CPU 106 cannot start the game, so that it finishes this routine without carrying out any processing. On the other hand, in the case where it is judged that the value of the credit amount C is greater than or equal to the value of the total bet amount in the previous game (step S12 YES), the CPU 106 subtracts the value of the total bet amount in the previous game from the value of the credit amount C, and stores this subtracted value into a prescribed memory region of the RAM 110. After that, the CPU 106 shifts the processing to the step S5.

When it is shifted to the step S5, the CPU 106 carries out the combination determination processing. More specific processing content of this combination determination processing is as follows.

In the combination determination processing, first, the CPU 106 determines a combination of symbols to be stopped along the above described payline. More specifically, the CPU 106 issues a command for generating a random number to the random number generator 112, and extract a random number in a prescribed range (“0” to “65535” in the present embodiment) generated by the random number generator 112. The CPU 106 stores this extracted random number into a prescribed memory region of the RAM 110. In the present embodiment, the random number is generated by the random number generator 112 that is provided at external of the CPU 106, but it is also possible to generate it by the calculation processing of the CPU 106, without providing this random number generator 112. The CPU 106 reads out the basic game random number table (see FIG. 13) and a table of specific combination for awarding a prize (not shown) stored in the ROM 108, and stores the read out basic game random number table and the table of specific combination for awarding a prize into a prescribed memory region of the RAM 110. The CPU 106 controls the stopping display of each reel according to the above described basic game random number table. The CPU 106 reads out the basic game random number table and the table of specific combination for awarding a prize stored in a prescribed memory region of the RAM 110, and refers to the basic game random number table by using the random number written in a prescribed memory region of the RAM 110 as a parameter, and thereby determines a combination of symbols to be stopped regarding the above described payline. When the specific combination for awarding a prize is determined in this way, the CPU 106 stores this determined specific combination for awarding a prize into a prescribed memory region of the RAM 110. The CPU 106 reads out the random number value and the specific combination for awarding a prize written in a prescribed memory region of the RAM 110, and determined a combination of symbols to be stopped according to the read out random number value and the specific combination for awarding a prize. At this point, a symbol arrangement table (not shown) stored in the ROM 108 is read out by the CPU 106 and stored into a prescribed memory region of the RAM 110 as well as referred. The CPU 106 stores the determined symbols to be stopped data into a prescribed memory region of the RAM 110. Alternatively, it is possible to determine the symbols to be stopped for each reel by using the above described basic game random number table.

When the combination of symbols to be stopped regarding the above described payline is determined, the CPU 106 judges whether the combination of symbols to be stopped regarding the payline is the specific combination for awarding a prize or not. Then, in the case where the combination of symbols to be stopped regarding the above described payline is the specific combination for awarding a prize, the CPU 106 sets a flag indicating that a prize is to be awarded active, for that specific combination for awarding a prize, in order to generate a prize corresponding to the combination of symbols which is the above described specific combination for awarding a prize. This flag indicating that a prize is to be awarded that is set active is stored into a prescribed memory region of the RAM 110 by the CPU 106. On the other hand, in the case where the combination of symbols to be stopped regarding the payline is the other combination, that is the combination for a lost game, the CPU 106 does not set the above described flag indicating that a prize is to be awarded active. After that, the CPU 106 shifts the processing to the step S6.

In the subsequent step S6, the CPU 106 starts the rotation of the mechanical reels 3A to 3E. More specifically, the CPU 106 rotates the mechanical reels 3A to 3E sequentially or simultaneously, according to the symbol arrangement table stored in the RAM 110.

After starting the rotation of the mechanical reels 3A to 3E, the CPU 106 counts the number of driving pulses transmitted to each one of the stepping motors 45A to 45E, and stores the count value into a prescribed memory region of the RAM 110. Every time the mechanical reels 3A to 3E are rotated, reset pulses are acquired, and these reset pulses of the mechanical reels 3A to 3E are inputted into the CPU 106 through the reel position detection circuit 46. By the reset pulses so obtained, the driving pulse count values written in the RAM 110 are cleared to “0”. In this way, the count values corresponding to the rotation positions in a range of one rotation for the mechanical reels 3A to 3E are stored in a prescribed region of the RAM 110. In the symbol arrangement table stored in the RAM 110, the rotation position of each of the mechanical reels 3A to 3E and the symbols of each of the mechanical reels 3A to 3E are set in correspondence. At a time of referring to the symbol arrangement table, the CPU 106 sets in correspondence the code numbers sequentially assigned to each constant rotation pitch of the mechanical reels 3A to 3E and the symbols codes indicating symbols provided in correspondence to these code numbers, with reference to the rotation positions at which the above described reset pulses occur.

When the rotation of the mechanical reels 3A to 3E is started, the CPU 106 waits for a prescribed time to elapse (step S7). At a timing where a prescribed time has elapsed (step S7 YES), the CPU 106 automatically stops the rotation of the mechanical reels 3A to 3E (step S8). More specifically, the CPU 106 stops the rotation of the mechanical reels 3A to 3E sequentially or simultaneously, such that the combination of stopped symbols corresponding to the specific combination for awarding a prize, that is determined at the step S5 according to the specific combination for awarding a prize that is written in a prescribed memory region of the RAM 110, will be displayed in the display region that has an interactive relationship with the player visually. After that, the CPU 106 shifts the processing to the step S9.

When it is shifted to the step S9, the CPU 106 judges whether a prescribed symbol combination is realized by the combination determination processing at the step S5 or not. More specifically, the CPU 106 judges according to a state of the flag indicating that a prize regarding the payline is to be awarded which is stored in a prescribed memory region of the RAM 110. In the case where the flag indicating that a prize is to be awarded is not set active, that is, in the case where the specific combination for awarding a prize is “others” (step S9 NO), the CPU 106 judges that the specific combination for awarding a prize is not realized, and finishes this routine. On the other hand, in the case where the flag indicating that a prize is to be awarded is set active, that is, in the case where the specific combination for awarding a prize is other than the above described “others” (step S9 YES), the CPU 106 shifts the processing to the step S10.

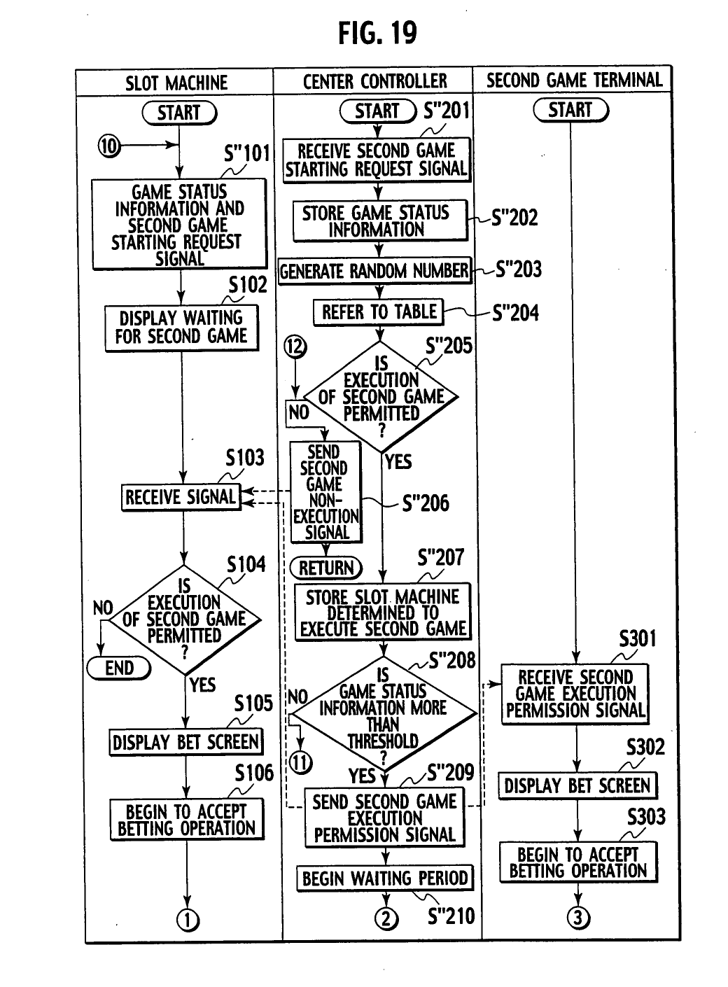

When it is shifted to the step S10, the CPU 106 judges whether the specific combination for awarding a prize is “BONUS” or not. More specifically, “BONUS” means symbols “BONUS” are aligned along the payline as shown in FIG. 20 to be described below. In the present embodiment, when “BONUS” is realized, the second game is started. The CPU 106 judges according to the specific combination for awarding a prize that is stored in a prescribed memory region of the RAM 110. In the case where the specific combination for awarding a prize is not “BONUS” (step S10 NO), the CPU 106 judges that the “BONUS” is not realized as the specific combination for awarding a prize, and shifts the processing to the step S13. On the other hand, in the case where the specific combination for awarding a prize is “BONUS” (step S10 YES), the CPU 106 judges that the “BONUS” is realized as the specific combination for awarding a prize, and shifts the processing to the step S1.

When it is shifted to the step S1, the CPU 106 carries out the second game processing shown in FIG. 17A to FIG. 17C to be described below. More specifically, the CPU 106 transmits the second game starting signal to the center controller 14. After carrying out the second game processing, the CPU 106 finishes this routine.

When it is shifted to the step S13, the CPU 106 pays out the number of coins according to the above described specific combination for awarding a prize. More specifically, the CPU 106 calculates the payout amount of coins corresponding to the above described specific combination for awarding a prize by referring to the basic game payout table. The CPU 106 reads out the credit amount stored in a prescribed memory region of the RAM 110, adds the above described calculated payout amount to this read out credit amount, and stores this added value in a prescribed region of the RAM 110. The CPU 106 displays that stored value on the credit amount display unit 49. After that, the CPU 106 finishes this routine.

Next, a description is given of a flow of a processing operation in the second game of the game system 10 using FIGS. 17 to 19.

Specifically, as one of the start condition, the center controller 14 executes a control to determine whether to start the second game when receiving each second game starting request signal and performs a control to cause the second game device to start the second game for the slot machine determined to start the second game. Such an example is described using FIGS. 17A to 17C. This is the first mode of the basic game and second game executed in the game system 10 of the present invention.

As another one of the start condition, the center controller 14 executes a control to determine whether to start the second game when the center controller 14 receives each second game starting request signal and the number of slot machines determined to start the second game has reached a certain number, the center controller 14 performs a control to cause the second game device to start the second game for the certain number of slot machines. Such an example is described using FIG. 18. This is the second mode of the basic game and second game executed in the game system 10 of the present invention.

As still another one of the start condition, the center controller executes a control to determine whether to start the second game when receiving each second game starting request signal, and the center controller 14 performs a control to cause the second game device to start the second game when a predetermined slot machine 13 is determined to start the second game among the slot machines 13 which have sent the second game starting request signals. Such an example is described using FIG. 19. This is the third mode of the basic game and second game executed in the game system 10 of the present invention.

The second game processing program of the slot machine 13 to be executed by the controller 100 containing the CPU 106 of the main slot machine 13, the second game processing program of the center controller 14 to be executed by the controller 200 containing the CPU 206 of the center controller 14, the second game processing program of the slot machine 13 to be executed by the controller 100 containing the CPU 106 of the slot machine 13, and the second game processing program of the second game terminal 15 to be executed by the controller 300 containing the CPU 306 of the second game terminal 15 will be described one by one based on the processing shown in FIGS. 17 to 19.

The programs shown in the flow chart of FIG. 17A to FIG. 17C are stored in the ROM 108 and the RAM 110 provided in the slot machine 13, the ROM 208 and the RAM 210 provided in the center controller 14, or the ROM 308 and the RAM 310 provided in the second game terminal 15. Then, the control operations according to the programs are executed by the controller 100 containing the CPU 106 of the slot machine 13, the controller 200 containing the CPU 206 of the center controller 14, or the controller 300 containing the CPU 306 of the second game terminal 15. In the following description, the CPU of each controller will be described as the subject of the controlling.

Next, a description is given of a process to implement the first mode of the second game.

First, using FIGS. 17A to 17C, a description is given of a processing program to implement the second game executed in the slot machine 13.

In step S101 of FIG. 17A, the CPU 106 sends the second game starting request signal requesting the execution start of the second game to the center controller 14. The second game starting request signal includes at least data specifying the slot machine 13, the number of credits bet when the “BONUS” combination has been established in the basic game, information on the payline, and the like.

The slot machine 13 performs display of waiting for the second game until receiving the permission to start execution of the second game from the center controller 14 (step S102). The CPU 106 of the slot machine 13 receives a signal related to the execution start of the second game from the center controller 14 (step S103) and determines according to the received determination result of the execution start of the second game whether the second game is allowed to be executed (step S104). When the CPU 106 receives the second game non-execution signal from the center controller 14, or when the second game which the CPU 106 is waiting for is not allowed to be executed, the CPU 106 terminates the second game process. On the other hand, when the CPU 106 receives the second game execution permission signal from the center controller 14, or when the second game is allowed to be executed, the CPU 106 transfers the process to step S105.

In the step S105, the CPU 106 displays the BET screen 70 shown in FIG. 25 later described on the liquid crystal display 30 of the slot machine 13 and begins a waiting period (a betting operation acceptance period) as a betting period during which the player can bet chips (step S106). The player can operate the touch panel 32 and bet his/her own chips in the BET areas 73 related to a number which the player predicts during the betting period allowing bets to be accepted. The place to bet and the number of bets depend on the number of credits and paylines bet in the basic game at the slot machine 13 as shown in the second game payout table (see FIG. 13). As for such a control method, the control may be performed by the CPU 206 of the center controller 14 after the CPU 106 of the slot machine 13 sends the bet information. Alternatively, the control may be performed by the CPU 106 of the slot machine 13 after sending the second game starting request signal in the step S101; receiving the condition allowing betting from the center controller 14 as data; and storing the data in the RAM 110 of the slot machine 13. The concrete betting method using the BET screen 70 is described in FIG. 25 below.

Thereafter, the CPU 106 determines whether the betting operation for the second game has been performed through the touch panel 32 (step S107). When determining that the betting operation has been performed, the CPU 106 sends a BET signal to the center controller 14 (step S108). This BET signal includes information on the bet made by the player at the slot machine 13 (information indicating the specified BET area 73, the number of chips bet on the specified BET area 73 (bet amount), and the like).

When receiving a signal concerning information indicating the BET condition of the other players (hereinafter, referred to as a BET condition signal) from the center controller 14, the CPU 106 displays the BET condition (see FIG. 25) on the liquid crystal display 30 (step S109).

The CPU 106 determines whether a command to close betting by the other players has been inputted (step S110). When determining that the command has been inputted, the CPU 106 sends the command signal to the center controller 14 (step S111).

The CPU 106 then determines whether the betting period end signal has been received from the center controller 14 (step S112). When determining that the betting period end signal has not been received, the CPU 106 returns the process to step S107 and repeatedly executes the process in the step S107 to step S111 until receiving the betting period end signal.

When determining in the step S112 that the betting period end signal has been received, the CPU 106 stops accepting the betting operation (step S113). Thereafter, the CPU 106 pays out credits based on a credit payout result received from the center controller 14 (step S114). Specifically, data of credits according to the payout of the roulette game is recorded in the RAM 110. The CPU 106 then transfers the process to step S115.

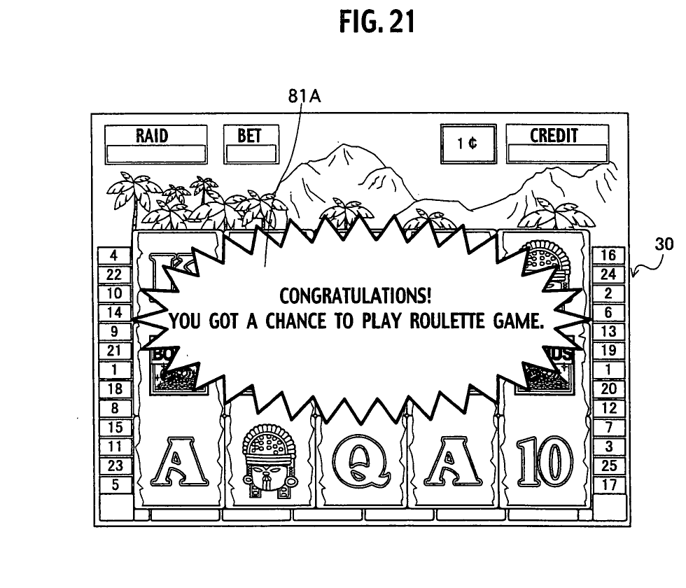

In the step S115, the CPU 106 determines whether to terminate the second game. Specifically, when there are remaining credits in the roulette game, the CPU 106 displays a small window 85 shown in FIG. 22 later described and determines whether to terminate the second game according to selection by the player. When there are no credits remaining, the player is out of options, and the CPU 106 terminates the second game. When there are no credits remaining in the roulette game or when the player selects termination of the roulette game (step S115: YES), the CPU 106 transfers the process to step S113. On the other hand, when there are credits remaining in the roulette game and the player selects to continue the roulette game (step S115: NO), the CPU 106 transfers the process to the step S101 of FIG. 17A. The CPU 106 sends again the second game starting signal to the center controller 14 to begin the betting period and proceed to the next game.

In the step S116, the CPU 106 sends the second game end signal to the center controller 14. When there are credits remaining in the roulette game, the CPU 106 reads the number of credits stored in a predetermined memory area for use in the basic game and then adds the read number of credits to credit data according to a payout of the roulette game stored in the RAM 110. The CPU 106 stores the thus obtained sum in a predetermined memory area of the RAM 110 and displays the same on the credit amount display unit 49 of the slot machine 13. Thereafter, the CPU 106 terminates this routine. At the slot machine 13, when the second game is terminated, the roulette game process is terminated.

As described above, when a payout is obtained in the roulette game as the second game, the credits increased by the obtained payout are changed into coins of the slot machine 13 at the end of the roulette game. In the basic game after the second game, the payout in the second game can be used as coins. Accordingly, the relationship between the basic game and second game increases, thus further adding spice to the games performed in the game system 10.

Next, a description is given of a processing program to implement processing of the second game executed in the center controller 14 using FIGS. 17A to 17C.

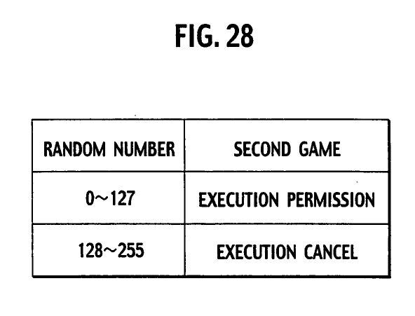

In step S201 of FIG. 17A, the CPU 206 receives the second game starting request signal sent from the CPU 106 of the slot machine 13 in the aforementioned step S101. The CPU 206 transfers the process to step S202. The CPU 206 generates a random number (step S202). The CPU 206 refers to a table shown in FIG. 28 based on the generated random number (step S203). The CPU 206 then determines whether to permit execution start of the second game (S204).

When execution of the second game is determined not to be permitted (step S204: NO) based on the generated random number and prepared table (see FIG. 28), the CPU 206 sends the second game non-execution signal to the slot machine 13 which has sent the second game starting request signal (step S205). On the other hand, when execution of the second game is permitted (step S204: YES), the CPU 206 sends the second game execution permission signal to the slot machine which has sent the second game starting request signal. The CPU 206 sends the second game starting signal to each second game terminal 15 (step S206).

The CPU 206 moves up the movable floor 18 which the slot machine 13 having sent the second game starting request signal and a chair are fixed to and then displays the start of the second game on the monitor 16 as shown in FIG. 20. Moving up the movable floor 18 of the slot machine 13 and such a second game starting message on the large monitor 16 can notify not only players at the other slot machines 13 but also third parties in the gaming facilities of the start of the second game. The CPU 206 then transfers the process to step S207.

In the step S207, the CPU 206 begins measuring a waiting period as an acceptance period during which players can bet from the point of time when the CPU 206 sends the second game permission signal (second game starting signal) to the slot machine 13. During this waiting period, the players of the slot machine 13 which joins the game can operate the touch panel 32 and bet their own chips in the BET areas 73 related to the number which the player predicts. Moreover, the players of the second game terminals 15 later described can bet whether the player of the second games (the players of the slot machines 13) will win.

After the step S207, upon receiving BET signals (signals indicating contents of the bets on the player of the second game) from the second game terminals 15, the CPU 206 stores information about the bets on the player of the second game based on the received signals and send the BET condition signal indicating such information (step S211).

Thereafter, upon receiving from any one of the slot machines 13 the command signal based on the command to close betting by the other players, the CPU 206 sends the betting period end signal to all the second game terminals 15 (step S212). Next, the CPU 206 determines whether the waiting period has remaining five minutes (step S213). The rest of the waiting period is displayed on the BET screen 70 of the second game device 11 through the BET time display unit 74 (see FIG. 7). When it is determined that the waiting period has remaining five minutes (step S213: YES), the CPU 206 inserts a ball 65 into the roulette board (step S214).

Namely, by activating the ball entering device first, the ball 65 is entered inside the roulette wheel, and the number determination processing by the roulette device 60 is carried out according to the game execution program. More specifically, after entering the ball 65, the CPU 206 rotates the wheel 62 at a prescribed rotational speed in a direction opposite from the ball entering direction by driving the driving motor in addition. The entered ball 65 rolls over the roulette wheel along the guide wall 66, and after that, a the rotational speed drops and the centrifugal force becomes weak, the ball 65 rolls down the slope of the frame body 61 toward inside, and reaches to the rotating wheel 62 (see FIG. 7).

Then, the ball 65 that rolled to the wheel 62 is accommodated into any one of the number pockets 63 by passing over the number display plates 64 on the outer side of the rotating wheel 62, and the number (any one of “0”, “00” and “1” to “36” shown in FIG. 7) described in the number display plate 64 corresponding to the number pocket 63 that accommodated the ball 65 becomes the winning number.

In addition, the CPU 206 takes the image of the roulette device 60 by the viewpoint movable camera 17 in response to the entering of the ball 65 inside the roulette wheel, and display it on the monitor 16. In this way, the player can watch the manner by which the winning number is determined in the roulette game by watching the monitor 16, without looking into the second game device 11. The monitor 16 may have its screen divided according to the need and display both the roulette device 60 and the BET screen 70.

The CPU 206 determines whether the waiting period has ended (step S215). When it is determined that the waiting period has not ended, the CPU 206 returns the process to the step S211. On the other hand, when it is determined that the waiting period has ended, the CPU 206 sends the betting period end signal indicating the end of the waiting period to the CPU 106 of the slot machine 13 and the CPUs 306 of the second game terminals 15 (step S216).

Next, the CPU 206 adds the number of credits corresponding to 0.5% of the total number of credits bet at the slot machine 13 and second game terminals 15 in the step S215 to the JP amount recorded in the JP accumulation memory area of the RAM 210 (step S217). The display of the JP display unit 75 is accordingly updated.

In step S218, the CPU 206 determines that the ball 65 is accommodated in one of the number pockets 63 and then activates the winning determination unit to determine the number associated to the number pocket having accommodated the ball 65. The CPU 206 then transfers the process to step S219.

In the step S219, the CPU 206 determines whether the chips bet at the slot machine 13 are won based on the number of the pocket which has been determined to accommodate the ball 65. Furthermore, in the step S219, the CPU 206 determines whether the player operating each second game terminal has won based on whether the player performing the second game at the slot machine 13 has won and the bet information of the second game terminal 15. The CPU 206 then transfers the process to step S220.

In the step S220, the CPU 206 executes a payout determination process. In the payout determination process, the CPU 206 recognizes winning chips bet on the winning number for each slot machine 13 and calculates the total number of credits to be paid to the slot machine 13 using a dividend cover for each BET area 73 of a second game payout table stored in a payout credit memory area of the ROM 208 (the number of credits paid per chip (per bet)). The CPU 206 also calculates credits to be paid to each winning second game terminal 15. Moreover, the CPU 206 displays information including the winning number, the number of winning persons, and the like on the monitor 16.

Subsequently, the CPU 206 executes a process to send the credit payout result of the roulette game based on the payout determination process of the step S221. Specifically, the CPU 206 outputs credit data corresponding to payouts to the winning slot machine 13 and second game terminals 15. The CPU 206 then transfers the process to step S222.

In the step S222, the CPU 206 drives a ball collecting unit provided under the wheel 62 and collects the ball 65 on the wheel 62. The collected ball 65 is again inserted into the wheel 62 of the roulette unit 60 in the subsequent games. Thereafter, upon receiving the second game end signal from the slot machine 13 having sent the second game starting signal, the CPU 206 moves down the movable floor 18 thereof and terminates this routine.

The monitor 16 may be configured to display video of demonstration of the second game or the like stored in the ROM 208 while every slot machine 13 does not play the second game but plays the basic game.

Lastly, a description is given of a second game processing program of the second game terminals 15 based on FIGS. 17A to 17C.

In step S301 of FIG. 17A, the CPU 306 of each second game terminal 15 receives the second game starting signal sent from the center controller 14 (step S301).

The CPU 306 of the second game terminal 15 displays the later-described BET screen 70 (see FIG. 25) on the display 93 based on the second signal starting signal and begins the waiting period as a betting period allowing betting on the player of the second game (step S303). The player of the second game terminal 15 can operate the touch panel 99 during the betting period when bets are acceptable and bet whether the player of the second game will win.

Thereafter, the CPU 306 determines whether there has been a betting operation performed through the touch panel 99 whether the player of the second game will win (step S304). When determining that the betting operation has been performed, the CPU 306 sends the BET signal to the center controller 14 (step S305). This BET signal includes the information on the bet made by the player at the second game terminal 15 (information indicating the game result of the specified player (winning or losing), the number of credits bet, and the like).

The second game terminal 15 determines whether the betting period end signal has been received (step S306). When determining that the betting period end signal has not been received, the CPU 306 returns the process to the step S303 and repeatedly executes the process of the steps S304 and S305 until receiving the betting period end signal. The betting period end signal is sent to the second game terminal 15 in the following cases of (I) and (II):

(I) the center controller 14 sends the betting period end signal to the second game terminal 15 based on the command signal sent by the slot machine 13 when the command to close betting by the other players is inputted into the slot machine 13 (step S212); and

(II) the center controller 14 sends the betting period end signal when the waiting period ends at the center controller 14 (step S216).

In the case of the above case (I), even when the waiting period ends at the second game terminal 15, the waiting period does not end at the slot machine 13 until the slot machine 13 receives the betting period end signal sent from the center controller 14 (step S216). On the other hand, in the case of (II), the waiting periods end simultaneously at the slot machine 13 and second game terminal 15.

When determining in step S306 that the betting period end signal is received, the CPU 306 stops accepting the betting operation (step S307). Thereafter, the CPU 306 of the second game terminal 15 pays out credits based on the credit payout result received from the center controller 14 (step S308).

The center controller 14 thus performs the control to determine whether to start the second game as the condition to start the second game when receiving the second game starting request signal. This can get the player interested in whether the second game is started, thus increasing the interest in the second game.

Next, a description is given of a process to implement the second mode of the second game. The second mode is the same as the first mode in that each slot machine 13 starts the second game upon receiving the second game execution permission signal from the center controller 14. The processing program to implement the second game executed at the slot machines 13 and a second game processing program of the second game terminals 15 can be those of the processing program of the first mode, and the detailed description thereof is omitted. In the processing of the center controller 14, the detailed description is omitted in terms of the same steps as those described in the first mode.

In the second mode, in step S′202 of FIG. 18, the CPU 206 of the center controller 14 receives the second game starting request signal sent from the CPU 106 of the slot machine 13 in the step S101. The CPU 206 transfers the process to the step S′202. The CPU 206 generates a random number (S′202). Referring to the table shown in FIG. 28 based on the generated random number (step S′203), the CPU 206 determines whether to permit execution start of the second game (step S′204).

When execution of the second game is determined not to be permitted (step S′204: NO) based on the generated random number and prepared table (see FIG. 28), the CPU 206 sends the second game non-execution signal to the slot machine 13 which has sent the second game starting request signal (step S′205).

On the other hand, when execution of the second game is permitted (step S′204: YES), the CPU 206 stores information which can specify the slot machine 13 permitted to start execution of the second game in the RAM 210 (see FIG. 10) of the center controller 14 or the like (step S′206).

Subsequently, the CPU 206 determines whether the number of slot machines 13 permitted to start execution of the second game has reached a certain number (step S′207). When the number of slot machines 13 permitted to start execution of the second game has not reached the predetermined number (step S′207: NO), the CPU S206 returns to the step S201 and waits for the second game starting request signal from another slot machine 13.

When the number of slot machines 13 permitted to start execution of the second game has not reached the certain number (step S′207: YES), the CPU 206 sends the second game execution permission signal to each slot machine 13 having sent the second game starting request signal and sends the second game starting signal to each second game terminal 15 (step S′208).

The CPU 206 moves up the movable floors 18 which the slot machines 13 each having sent the second game starting request signal and chairs are fixed to and displays start of the second game on the monitor 16 as shown in FIG. 20. Moving up the movable floors 18 of the slot machines 13 and such a second game start message on the large monitor 16 allow not only players at the other slot machines 13 but also the third parties in the gaming facilities to know the start of the second game. The CPU 206 then transfers the process to step S′209.

In step S′209, the CPU 206 begins measuring the waiting period which is the acceptance period during which players can bet starting from the time when the CPU 206 sends the second game execution permission signal to the slot machine 13. During this waiting period, the player of the slot machine 13 who joins the game can operate the touch panel 32 of the liquid crystal display 30 to bet his/her own chips in the BET areas 73 related to a number that the player predicts. The players of the later-described second game terminals 15 can bet whether the player of the second game (player of the slot machine 13) will win. The process after the step S′209 follows the flowcharts shown in FIGS. 17B and 17C.

As the condition to start the second game, the center controller 14 thus performs the control to determine whether to start the second game when receiving the second game starting request signal and performs the control to start the second game according to whether the number of slot machines determined to start execution of the second game has reached the certain number. This can get the player interested in whether the second game is started, thus increasing the interest in the second game.

Next, a description is given of a process to implement of the third mode of the second game. The third mode is the same as the other modes in that each slot machine 13 starts the second game upon receiving the second game execution permission signal from the center controller 14. The processing program to implement the second game executed at the slot machines 13 and a second game processing program of the second game terminals 15 can be those of the processing program of the first mode, and detailed description thereof is omitted. In the process of the center controller 14, the detailed description is omitted in terms of the same steps as those described as the first mode. In the third mode, the CPU 106 of each slot machine 13 sends the second game starting request signal requesting execution start of the second game to the center controller 14 in the step S″101 of FIG. 19. The second game starting request signal includes at least the data specifying the slot machine 13, the number of credits bet when the “BONUS” combination has been established in the basic game, the information of the payline, and the like. The CPU 106 also sends information indicating a game status in the basic game of the slot machine 13 to the center controller 14. The information indicating the game status includes the number of payouts won with respect to the number of times that the basic game has been played, that is, a payout rate, and the like.

In the step S″201 of FIG. 19, the CPU 206 of the center controller 14 receives the second game starting request signal sent and game status information sent from the CPU 106 of the slot machine 13 in the step S″101. The CPU 206 stores the game status information of the slot machine 13 which has sent the received second game starting request signal in the RAM 210 or the like (step S″202) and then transfers the process to the step S″202.

The CPU 206 generates a random number (step S″203). The CPU 206 generates a random number (S′203). Referring to the table shown in FIG. 28 based on the generated random number (step S″204), the CPU 206 determines whether to permit execution start of the second game (step S′205).

When execution of the second game is determined not to be permitted (step S′205: NO) based on the generated random number and prepared table (see FIG. 28), the CPU 206 sends the second game non-execution signal to the slot machine 13 which has sent the second game starting request signal (step S′206). On the other hand, when execution of the second game is permitted (step S′205: YES), the CPU 206 stores information which can identify the slot machine 13 permitted to start execution of the second game in the RAM 210 or the like (step S″207).

Subsequently, the CPU 206 determines whether the game status information exceeds a threshold value (step S″208). When the game status information does not exceed the threshold value (step S″208: NO), the CPU 206 sends the second game non-execution signal to the slot machine 13 which has sent the second game starting request signal (step S″206). When the game status information exceeds the threshold value (step S″208: YES), the CPU 206 sends the second game execution permission signal to the slot machine 13 which has sent the second game starting request signal. The CPU 206 also sends the second game starting signal to each second game terminal 15 (step S″209).

The CPU 206 moves up the movable floor 18 which the slot machine 13 having sent the second game starting request signal and a chair are fixed to and displays start of the second game on the monitor 16 as shown in FIG. 20. Moving up the movable floors 18 of the slot machines 13 and such a second game start message on the large monitor 16 allow not only players at the other slot machines but also the third parties in the gaming facilities to know the start of the second game. The CPU 206 then transfers the process to step S″210.

In step S″210, the CPU 206 begins measuring the waiting period which is an acceptance period during which players can bet starting from the time when the CPU 206 sends the second game execution permission signal to the slot machine 13. During this waiting period, the player of the slot machine 13 who joins the game can operate the touch panel 32 of the liquid crystal display 30 to bet his/her own chips in the BET areas 73 related to a number which the player predicts. The players of the later-described second game terminals 15 can bet whether the player of the second game (player of the slot machine 13) will win. The process after the step S″210 follows the flowcharts shown in FIGS. 17B and 17C.

As described above, the slot machine 13 sends the payout rate in the basic game to the center controller 14. Accordingly, the center controller 14 can determine whether to permit execution start of the second game based on the payout rate. For example, when the center controller 14 receives the second game starting request signal from a player who has continued to lose the basic game, or, from the slot machine 13 which has received no payout over a number of times of the basic game, and execution is determined to be permitted, the center controller 14 can determine to permit execution of the second game for the slot machine 13 of interest.

In the following, the basic game and second game executed in the game system 10 are concretely described showing display examples of the slot machine 13, second game terminals 15, large panel 16, and the like.

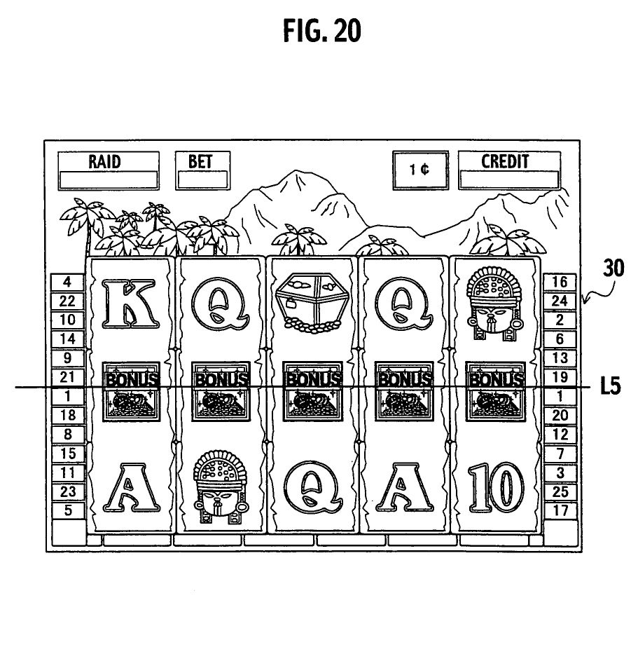

FIGS. 20 and 21 show display examples of the basic game at each slot machine 13 of the embodiment. As shown in FIG. 20, symbols are being stopped and displayed on the liquid crystal display 30 of the slot machine 13. In the case of this embodiment, symbols “BONUS” are aligned in a horizontal line in center part, and the “BONUS” combination is established on the payline L5. As previously described, when the condition in which the symbols “BONUS” are aligned on the payline L5, a small window 81A including letters “CONGRATULATIONS! YOU GOT A CHANCE TO PLAY ROULETTE GAME” is displayed on the liquid crystal display 30 as shown in FIG. 21. Such an effect allows the player to know that the right to make a transition to the roulette game as the second game is given to the player. The CPU 106 of the slot machine 13 sends the second game starting request signal to the center controller 14. At this time, for example, when the second game is in play, the second game starting request signal is a request to start execution of the next second game.

FIG. 22 shows a display example when the condition allowing execution of the second game is established at the slot machine 13 of the embodiment but the slot machine 13 cannot make a transition to the second game immediately. Specifically, while the process to determine whether to permit execution start of the second game is being performed by the aforementioned process of FIG. 17A, 18, or 19 at the center controller 14 after the second game starting request signal is sent from the CPU 106 of the slot machine 13 to the center controller 14, a small window 81B including letters “CHANCE FOR ROULETTE GAME!” is displayed on the liquid crystal display 30. Such display allows the player to know that the symbols “BONUS” have been aligned and the player has got the chance to make a transition to the roulette game as the second game but cannot make a transition to the roulette game immediately. This can prevent the player from forgetting having the chance to make a transition to the roulette game and allow the player to recognize that the player has not yet lose the chance to make a transition to the roulette game. Moreover, the process described using FIG. 18 may be configured to display a counter of the number of persons needed to start execution of the second game and decrement the displayed number each time any one of the players get a chance to start execution of the second game. Such display allows the player to know how many players who get the chance to start execution of the second game are required to start execution of the second game, thus raising expectations for the second game.

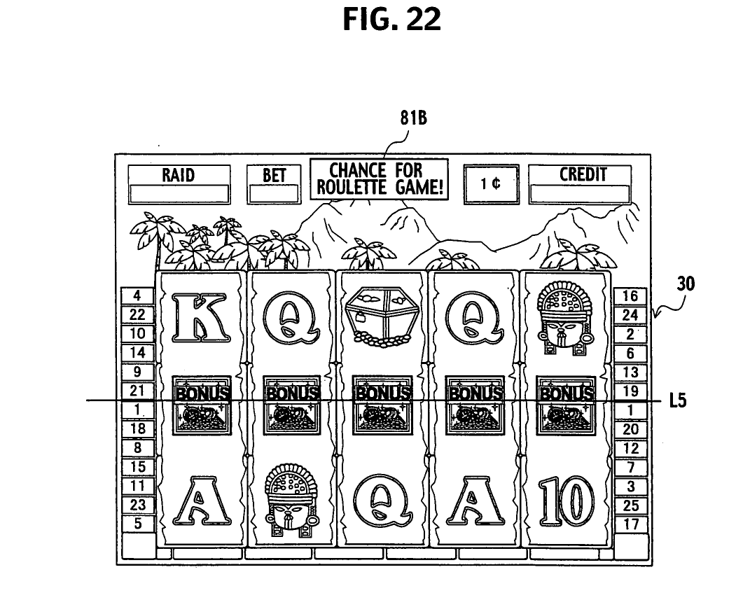

FIG. 23 shows a display example when each slot machine 13 of the embodiment waiting for the second game is allowed to make a transition to the second game. When the slot machine 13 of the embodiment waiting for the second game becomes allowed to execute the second game by the aforementioned process of FIG. 17A, 18, or 19, the display at the slot machine 13 may be immediately shifted to the screen of the second game as shown in FIG. 25. However, depending on the play status at that time (for example, a case where the player of the slot machine 13 is continuously winning payouts), it can be predicted that the player wants to continue to enjoy the basic game. Automatically making a transition to the roulette game in such a case removes enthusiasm for games. Accordingly, when the slot machine 13 waiting for the second game becomes allowed to make a transition to the second game, a window asking the player whether the player wants to break the basic game may be displayed so that the player selects whether to start the second game immediately or continue the basic game.

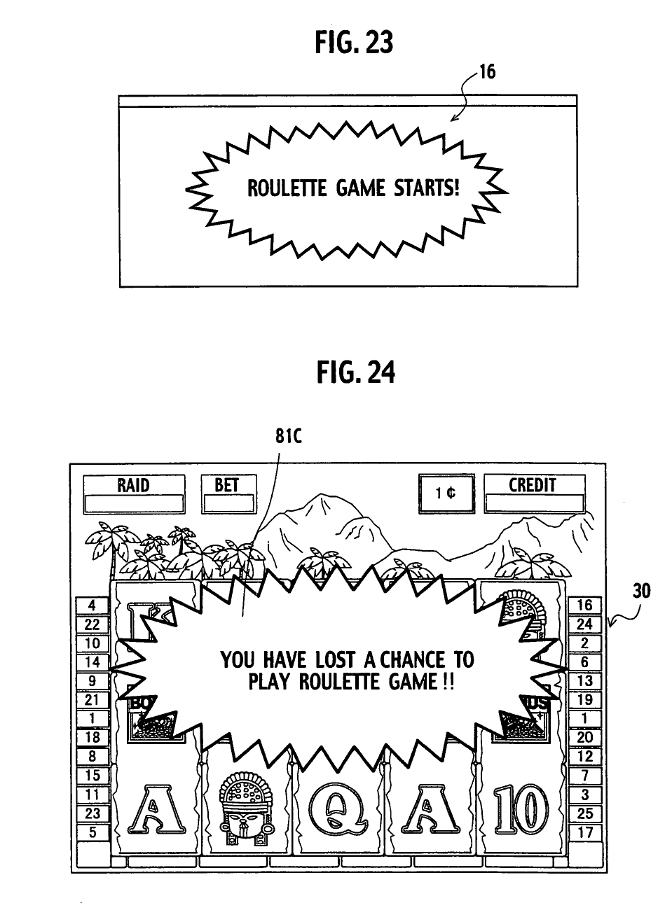

FIG. 24 shows a display example when each slot machine 13 of the embodiment waiting for the second game is not permitted to start execution of the second game, or when the player thereof loses the chance to play the second game. When execution of the second game is determined not to be permitted by the aforementioned process of FIG. 17A, 18, or 19 at the center controller 14 while the slot machine 13 is waiting for the second game, a small window 81C including letters “YOU LOSE A CHANCE TO PLAY SECOND GAME!” is displayed on the liquid crystal display 30 as shown in FIG. 24. Such display allows the player to know that the symbols “BONUS” have been aligned and the player have once got the chance to make a transition to the roulette game as the second game but lost the same. The player therefore can know that the second game is not always started even if the player can get a chance to execute the second game, thus further raising expectations for the second game.

FIG. 25 shows an exemplary display of the second game in the slot machine 13. More specifically, it shows an exemplary display to be displayed on the liquid crystal display 30 at a time of making the betting operation of the roulette game. The similar display is presented also on the display 93 of the second game terminal 15.

First, this BET screen 70 is displayed on the liquid crystal display 30 of the slot machine 13 and the display 93 of the second game terminal 15. Here, it will be described as displayed on the liquid crystal display 30 of the slot machine 13. On the lower side of the betting board 71 displayed on the BET screen 70, a result log display unit 72, unit BET buttons 77, a payout amount display unit 78 and a credit amount display unit 79 are displayed sequentially from a upper left side of the screen. The payout amount display unit 78 and the credit amount display unit 79 are displaying those in the roulette game, unlike the payout amount display unit 48 and the credit amount display unit 49 of the slot machine 13.

The unit BET buttons 77 are buttons for betting chips on the BET area 73 (on a grid of a number and a mark or on a line forming a grid) specified by the player. The unit BET buttons 77 comprises four types of a 1-BET button 77A, 5-BET button 77B, 10-BET button 77C and 100-BET button 77D.

The player specifies an area to bet by displaying a cursor 80 to be described below, by directly pressing the BET area 73 to be bet on a screen by a finger or the like first. In that state, when the 1-BET button 77A is pressed, the player can bet chips in unit of one chip (the number of bet chips will be increased sequentially like 1, 2, 3 and so on whenever the 1-BET button 77A is pressed by the finger or the like). When the 5-BET button 77B is pressed, the player can bet chips in unit of five chips (the number of bet chips will be increased sequentially like 5, 10, 15 and so on whenever the 5-BET button 77B is pressed by the finger or the like). When the 10-BET button 77C is pressed, the player can bet chips in unit of ten chips (the number of bet chips will be increased sequentially like 10, 20, 30 and so on whenever the 10-BET button 77C is pressed by the finger or the like). When the 100-BET button 77D is pressed, the player can bet chips in unit of one hundred chips (the number of bet chips will be increased sequentially like 100, 200, 300 and so on whenever the 100-BET button 77D is pressed by the finger or the like).

Consequently, even at a time of betting many chips, its operation can be simplified. One coin to be used in the basic game of the slot machine 13 corresponds to one chip to be used in the second game.

The places to bet chips are not limited to one place. After pressing the unit BET button, by enabling the player to specify another BET area 73, it becomes possible to make the betting operations for a plurality of places.

The payout amount display unit 78 displays the number of bet chips of the player in the previous game, and the payout credit amount. Here, the number obtained by subtracting the number of bet chips from the payout credit amount is the credit amount newly obtained by the player in the previous game. In this exemplary display, it is the first game since a transition to the second game is made by the slot machine 13 so that the number of bet chips and the payout credit amount are both “0”.

In addition, the credit amount display unit 79 displays the credit amount currently owned by the player. This credit amount is decreased according to the number of bet chips when the chips are bet (one credit for one bet chip). When the bet chips become win and the payout of credit is made, the credit amount will be increases as much as the number of payout chips. When the credit amount owned by the player becomes “0”, it becomes game over. In this exemplary display, the case where a transition to the second game is made when the credit amount at the slot machine 13 is “1” is shown. Namely, 20 chips are bet on “2to1” which covers “1”, “4”, “7”, “10” and so on, and 1 chip is bet on four numbers “5”, “6”, “7” and “8”, so that “79” obtained by subtracting “21 (20+1)” from the number of chips “100” at a time of the transition is displayed as the credit amount.

On the betting board 71, the cursor 80 for indicating the BET area 73 currently selected by the player is displayed.

When the player makes the bet on the BET screen 70 in a configuration described above, first the BET area 73 (on a grid of a number and a mark, or a line forming a grid) to be bet is specified on a screen by directly pressing it by the finger. As a result, the cursor 80 moves to the specified BET area 73.

After that, by pressing each unit button (1-BET button 77a, 5-BET button 77B, 10-BET button 77C, 100-BET button 77D) of the unit BET buttons 77, the chips in that unit number are bet on the specified BET area 73. For example, by pressing the 10-BET buttons 77C four times, the 5-BET button 77B once, and 1-BET button 77A three times, a total 48 chips can be bet. The player can make the betting operation by operating a terminal at hand using these functions.

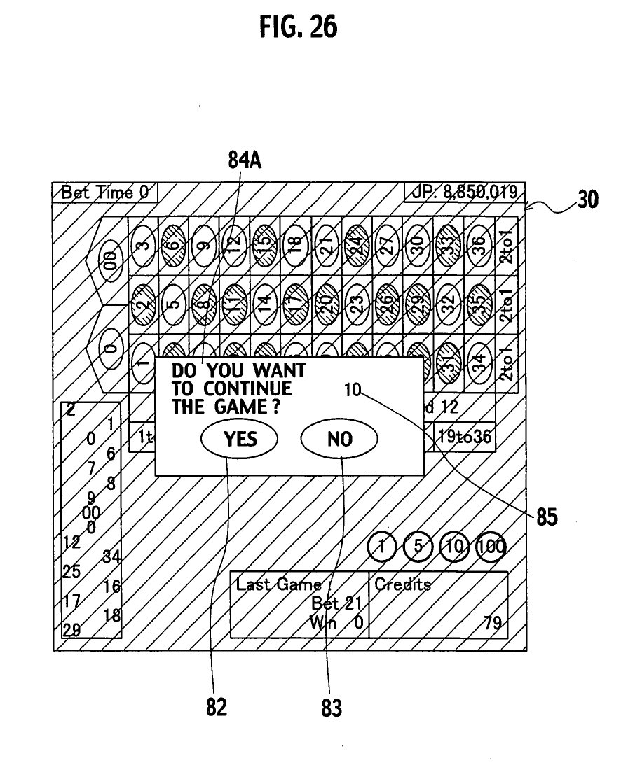

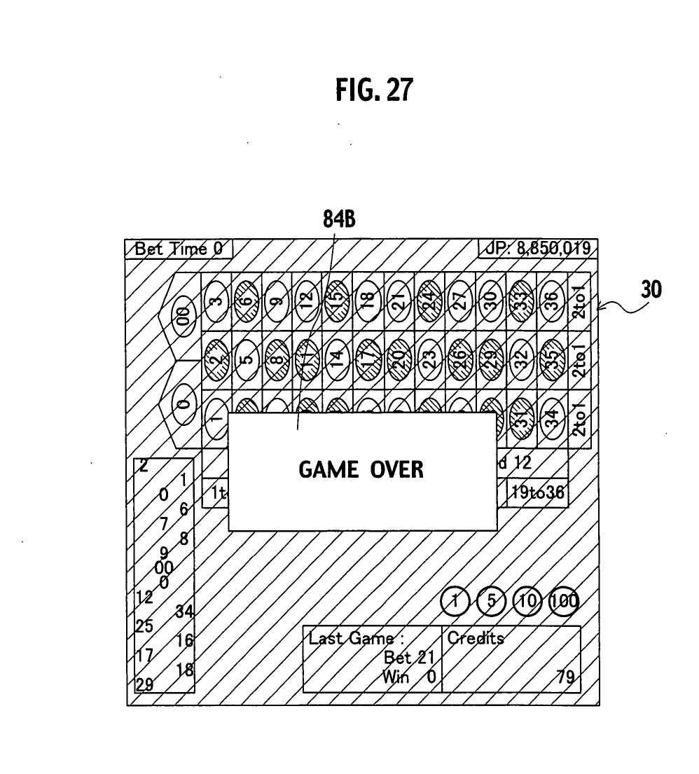

FIGS. 26 and 27 show display examples of the screens displayed on the liquid crystal display 30 after the payout process in the step S114 of FIG. 17C. FIG. 26 is a display example of the screen displayed on the liquid crystal display 30 of the slot machine 13 when there are credits remaining in the roulette game. In this case, a small window 84A asking the player whether to continue the game is displayed in the center of the screen. In the upper right part of the window, a countdown number 85 is displayed. The countdown number 85 sequentially counts down like 10, 9, 8, . . . When the player presses any one of the YES and NO buttons 82 and 83, which are provided in the lower part of the image, through the touch panel 32 (see FIG. 5) before the countdown number 85 reaches 0 or when the player presses the NO button 83 during the countdown, the roulette game is determined to be terminated. A small window 84B telling the end of the game as shown in FIG. 27 is then displayed. When there are no credits remaining in the roulette game, the screen of FIG. 27 is shown on the liquid crystal display 30 without FIG. 26 being displayed, and the roulette game ends.

As described above, in the game system and playing method according to the embodiment, when a predetermined combination of symbols, for example, “BONUS” or the like stops on the payline L5 while the basic game is being played at the slot machine 13, the process to determine whether to permit execution start of the second game is performed at the center controller 14 by the aforementioned different processes of FIGS. 17A to 19. When the execution start of the second game is permitted at the center controller 14, the second game device 11 starts the roulette game as the second game. In this case, each slot machine 13 serves as a terminal at which a betting operation of the roulette game can be performed.

In the roulette game, the player uses credits given by the combination of symbols “BONUS” at the basic game. The roulette game ends usually when the player wants to end the play and when there are no credits to bet remaining. Accordingly, the player can play the roulette game any number of times depending on the playing way of the player.

A plurality of second game terminals 15 dedicated to the roulette game are provided, accordingly it becomes possible for the third person in the gaming facility to join only the roulette game even if he is not playing the game at the slot machine 13, so that it is possible to arouse a high interest with respect to the game.

In the roulette game, the rules such as places that can be bet or betting at multiple places by a single play is allowed or not, and the payout in the case of win, are determined according to the second game payout table. The second game payout table can be set differently for different terminals to be used in playing the game, and the payout rate can be changed according to the conditions in the basic game. Consequently, it becomes possible to make such various settings, so that it becomes possible to provide the game in which the player can maintain the interest to the game.

In the above, the embodiments of the game system according to the present invention have been described, but they are only showing concrete examples. Namely, the above described embodiments are not intended to limit the present invention, and the concrete configuration of each means or the like can be appropriately changed by design. Also, the concrete configuration of each means or the like can be replaced by other means having equivalent functions, or a combination of a plurality of means each having a part of functions, and can also be realized by a part of functions of the other means having expanded functions. Also, the effects described in the embodiments of the present invention are only listing the most preferable effects arising from the present invention, and the effects of the present invention are not limited to those described in the embodiments of the present invention.

For example, as the second game, the roulette game has been described, but without being limited to that, it may be the card game such as a poker or the gambling such as quiz. It may be a competition with a computer or another player using an equipment that requires physical actions such as a cycling machine or a horse riding exercise device.

What is claimed is:

1. A game system comprising:
a plurality of slot machines, each slot machine including a controller operable to control at least a basic game and a second game and being capable of making a transition to the second game when a predetermined condition is established in the basic game, each slot machine generating a right to execute the second game when the predetermined condition is established in the basic game and sending a second game starting request signal requesting execution start of the second game;
a second game device performing the second game, the second game device being provided as a physically separate device from the slot machines;
a display adapted to display an image according to a game status of the second game, the display being visible from a plurality of players playing the second game at the slot machines and the second game device; and
a center controller capable of communicating with the slot machines, the second game device, and the display, the center controller operable to, when the center controller receives the second game starting request signal from at least one of the plurality of slot machines and a predetermined start condition is established, cause the second game device to start the second game for the slot machine having got the right to execute the second game and sent the second game starting request signal.

2. The game system according to claim 1, wherein
the center controller is operable to determine whether to start execution of the second game when receiving the second game starting request signal and, when the execution of the second game is determined to start, cause the second game device to start the second game for the slot machine having got the right to execute the second game and sent the second game starting request signal.

3. The game system according to claim 2, wherein
the center controller is operable to determine whether to start execution of the second game when receiving the second game starting request signal and, when the number of slot machines determined to start the execution of the second game has reached a certain number, cause the second game device to start the second game for the certain number of slot machines.

4. The game system according to claim 2, wherein
the center controller is operable to determine whether to start execution of the second game when receiving the second game starting request signal and, when a predetermined one of the slot machines each having sent the second game starting request signal is determined to start execution of the second game, cause the second game device to start the second game for the slot machine having got the right to execute the second game and sent the second game starting request signal.

5. A game system comprising:
a plurality of slot machines, each slot machine including a controller operable to control at least a basic game and a second game and being capable of making a transition to the second game when a predetermined condition is established in the basic game, each slot machine generating a right to execute the second game when the predetermined condition is established in the basic game and sending a second game starting request signal requesting execution start of the second game;
a second game device performing the second game, the second game device being provided as a physically separate device from the slot machines;
a display adapted to display an image according to a game status of the second game, the display being visible from a plurality of players playing the second game at the slot machines and the second game device; and
a center controller capable of communicating with the slot machines, the second game device, and the display, the center controller operable to receive the second game starting request signal from at least one of the plurality of slot machines; determine whether to start execution of the second game; and when the execution of the second game is determined to start, cause the second game device to start the second game for the slot machine having got the right to execute the second game and sent the second game starting request signal.

6. The game system according to claim 5, wherein
the center controller is operable to determine whether to start execution of the second game when receiving the second game starting request signal and, when the number of slot machines determined to start the execution of the second game has reached a certain number, cause the second game device to start the second game for the certain number of slot machines.

7. The game system according to claim 5, wherein
the center controller is operable to determine whether to start execution of the second game when receiving the second game starting request signal and, when a predetermined one of the slot machines each having sent the second game starting request signal is determined to start execution of the second game, cause the second game device to start the second game for the slot machine having sent the second game starting request signal.

8. A game system comprising:
a plurality of slot machines, each slot machine including a controller operable to control at least a basic game and a second game and being capable of making a transition to the second game when a predetermined condition is established in the basic game, each slot machine generating a right to execute the second game when the predetermined condition is established in the basic game and sending a second game starting request signal requesting execution start of the second game;
a second game device performing the second game, the second game device being provided as a physically separate device from the slot machines;
a display adapted to display an image according to a game status of the second game, the display being visible from a plurality of players playing the second game at the slot machines and the second game device; and
a center controller capable of communicating with the slot machines, the second game device, and the display, the center controller operable to receive the second game starting request signal from at least one of the plurality of slot machines, determine whether to start execution of the second game; and either, when the number of slot machines determined to start the execution of the second game has reached a certain number, cause the second game device to start the second game for the certain number of slot machines or, when a predetermined one of the slot machines each having sent the second game starting request signal is determined to start execution of the second game, cause the second game device to start the second game for the slot machine having sent the second game starting request signal.

9. A game control method executed in a game system, the game system including:
a plurality of slot machines, each slot machine including a controller operable to control at least a basic game and a second game and being capable of making a transition to the second game when a predetermined condition is established in the basic game, each slot machine generating a right to execute the second game when the predetermined condition is established in the basic game and sending a second game starting request signal requesting execution start of the second game;
a second game device performing the second game, the second game device being provided as a physically separate device from the slot machines;
a display adapted to display an image according to a game status of the second game, the display being visible from a plurality of players playing the second game at the slot machines and the second game device; and
a center controller capable of communicating with the slot machines, the second game device, and the display, the game control method comprising the steps of:
receiving by the center controller the second game starting request signal from at least one of the plurality of slot machines;
determining by the center controller whether a predetermined start condition is established; and
causing by the center controller the second game device to start the second game for the slot machine having got the right to execute the second game and sent the second game starting request signal.

10. The game control method according to claim 9, further comprising the steps of:
determining by the center controller whether to start execution of the second game when the center controller receives the second game starting request signal; and
when the execution of the second game is determined to start, causing by the center controller the second game device to start the second game for the slot machine having got the right to execute the second game and sent the second game starting request signal.

11. The game control method according to claim 10, further comprising the steps of:
determining by the center controller whether to start execution of the second game when the center controller receives the second game starting request signal; and
when the number of slot machines determined to start the execution of the second game has reached a certain number, causing by the center controller the second game device to start the second game for the certain number of slot machines.

12. The game control method according to claim 10, further comprising the steps of:
when the center controller receives the second game starting request signal and a predetermined one of the slot machines each having sent the second game starting request signal is determined to start execution of the second game, causing by the center controller the second game device to start the second game for the slot machine having got the right to execute the second game and sent the second game starting request signal.

13. A game control method executed in a game system, the game system including:
a plurality of slot machines, each slot machine including a controller operable to control at least a basic game and a second game and being capable of making a transition to the second game when a predetermined condition is established in the basic game, each slot machine generating a right to execute the second game when the predetermined condition is established in the basic game and sending a second game starting request signal requesting execution start of the second game;
a second game device performing the second game, the second game device being provided as a physically separate device from the slot machines;
a display adapted to display an image according to a game status of the second game, the display being visible from a plurality of players playing the second game at the slot machines and the second game device; and
a center controller capable of communicating with the slot machines, the second game device, and the display, the game control method comprising the steps of:
receiving by the center controller the second game starting request signal from at least one of the plurality of slot machines;
determining by the center controller whether to start execution of the second game; and
when the execution of the second game is determined to start, causing by the center controller the second game device to start the second game for the slot machine having got the right to execute the second game and sent the second game starting request signal.

14. The game control method according to claim 13, further comprising the steps of:
determining by the center controller whether to start execution of the second game when the center controller receives the second game starting request signal; and
when the number of slot machines determined to start the execution of the second game has reached a certain number, causing by the center controller the second game device to start the second game for the certain number of slot machines.

15. The game control method according to claim 13, further comprising the steps of:
when the center controller receives the second game starting request signal and a predetermined one of the slot machines each having sent the second game starting request signal is determined to start execution of the second game, causing by the center controller the second game device to start the second game for the slot machine having got the right to execute the second game and sent the second game starting request signal.

16. A game control method executed in a game system, the game system including:
a plurality of slot machines, each slot machine including a controller operable to control at least a basic game and a second game and being capable of making a transition to the second game when a predetermined condition is established in the basic game, each slot machine generating a right to execute the second game when the predetermined condition is established in the basic game and sending a second game starting request signal requesting execution start of the second game;
a second game device performing the second game, the second game device being provided as a physically separate device from the slot machines;
a display adapted to display an image according to a game status of the second game, the display being visible from a plurality of players playing the second game at the slot machines and the second game device; and
a center controller capable of communicating with the slot machines, the second game device, and the display, the game control method comprising the steps of:
receiving by the center controller the second game starting request signal from at least one of the plurality of slot machines;
determining by the center controller whether to start execution of the second game; and either,
when the number of slot machines determined to start the execution of the second game has reached a certain number, causing by the center controller the second game device to start the second game for the certain number of slot machines or, when a predetermined one of the slot machines each having sent the second game starting request signal is determined to start the execution of the second game, causing by the center controller the second game device to start the second game for the slot machine having got the right to execute the second game and sent the second game starting request signal.
